(19) United States
(12) Patent Application Publication
(10) Pub. No.: US 2024/0056240 A1
(43) Pub. Date: Feb. 15, 2024

(54) OVER-THE-AIR COMPUTATION METHODS BASED ON BALANCED NUMBER SYSTEMS FOR FEDERATED EDGE LEARNING (FEEL)

(71) Applicant: UNIVERSITY OF SOUTH CAROLINA, COLUMBIA, SC (US)

(72) Inventor: ALPHAN SAHIN, COLUMBIA, SC (US)

(21) Appl. No.: 18/363,809

(22) Filed: Aug. 2, 2023

Related U.S. Application Data
(60) Provisional application No. 63/394,438, filed on Aug. 2, 2022.

(51) Int. Cl. H04L 5/00; H04L 25/02

(52) U.S. Cl. CPC H04L 5/0007; H04L 5/0046; H04L 25/0254

(57) ABSTRACT

A digital over-the-air computation (OAC) scheme achieves continuous-valued (analog) aggregation for federated edge learning (FEEL). The average of a set of real-valued parameters can be calculated approximately by using the average of the corresponding numerals, where the numerals are obtained based on a balanced number system. By exploiting this key property, local stochastic gradients are encoded into a set of numerals. Next, positions of the activated orthogonal frequency division multiplexing (OFDM) subcarriers are determined by using the values of the numerals. To eliminate the need for a precise sample-level time synchronization, channel estimation overhead, and power instabilities due to the channel inversion, a non-coherent receiver is used at the edge server (ES) and pre-equalization at the edge devices (EDs) is not used. To improve the test accuracy of FEEL with the presently disclosed method, we introduce the concept of adaptive absolute maximum (AAM). Numerical results show test accuracy can reach up to 98% for heterogeneous data distribution using presently disclosed scheme with AAM for FEEL.

### PRIORITY CLAIM

The present application claims the benefit of priority of U.S. Provisional Patent Application No. 63/394,438, titled OVER-THE-AIR COMPUTATION METHODS BASED ON BALANCED NUMBER SYSTEMS FOR FEEL, filed Aug. 2, 2022, and which is fully incorporated herein by reference for all purposes.

### BACKGROUND OF THE PRESENTLY DISCLOSED SUBJECT MATTER

### I. Introduction

Federated edge learning (FEEL) is a distributed learning framework that leverages the computational powers of EDs and uses the local data at the EDs without compromising their privacy to train a model.

However, the communication aspect of FEEL stands as one of the main bottlenecks. To address this issue, one of the promising solutions is to perform the aggregation with over-the-air computation methods that harness the interference that naturally occurs in wireless systems. However, developing a broadband AirComp scheme that allows analog computation via a digital scheme is not trivial. In this disclosure, we address this issue with a novel AirComp scheme.

Over-the-air computation (OAC) refers to the computation of mathematical functions by exploiting the signal-superposition property of wireless multiple-access channel [1], [2]. To reduce the utilization of limited wireless resources, it was initially considered for wireless sensor networks [3]. With the same motivation, OAC has recently gained increasing attention in the literature for applications such as distributed learning or wireless control systems [4]-[6]. For example, federated edge learning (FEEL), one of the promising distributed edge learning frameworks, aims to implement federated learning (FL) [7] over a wireless network.

With FEEL, the task of model training is distributed across multiple edge devices (EDs) and the data uploading is avoided to promote user-privacy [5], [8]. Instead of data samples, EDs share a large number of local stochastic gradients (or local model parameters) with an edge server (ES) for aggregation, e.g., averaging.

However, typical orthogonal user multiplexing methods such as orthogonal frequency division multiple access (OFDMA) can be wasteful in this scenario since the ES may not be interested in the local information of the EDs but only in a function of them.

Similarly, a control system that requires an input that is a function of many Internet-of-Things (IoT) devices' readings can suffer from high latency since the available spectrum for these networks is often limited and the OAC can address the latency issues by calculating the functions, e.g., difference equations [6], over the air.

Despite the motivations for OAC, it is challenging to realize a reliable OAC scheme due to the detrimental impact of wireless channels on the OAC. To address this issue, a majority of the state-of-the-art OAC methods rely on pre-equalization techniques [9]-[17]. However, a pre-equalizer can impose stringent requirements on the underlying mechanisms such as time-frequency synchronization, channel estimation, and channel prediction, which can be challenging to satisfy under the non-stationary channel conditions [18], [19]. Also, the typical equalization or phase correction methods used at the receiver for traditional multiple-access schemes, e.g., OFDMA, cannot be directly employed for OAC to compensate the channel distortion or imperfect synchronization as the impact of distortions on the received symbols after the superposition often do not satisfy the distributive law of mathematical operations.

Another issue is that most of the OAC schemes use analog modulation schemes to achieve a continuous-valued computation. However, analog modulations are more susceptible to noise as compared to digital schemes. Although there are digital aggregation methods, e.g., one-bit broadband digital aggregation (OBDA) [12], frequency-shift keying (FSK)-based majority vote (MV) (FSK-MV) [20], and pulse-position modulation (PPM)-based MV (PPM-MV) [21], by relying on specific training approaches, i.e., distributed training by the MV with sign stochastic gradient descent (signSGD) [22], these schemes do not allow one to compute a continuous-valued function.

### A. Related Work

1) Over-the-air computation: In the literature, OAC schemes are particularly investigated to reduce the per-round communication latency of FEEL. In [9], broadband analog aggregation (BAA) that modulates the orthogonal frequency division multiplexing (OFDM) subcarriers with the model parameters is proposed. To overcome the impact of the multipath channel on the transmitted signals, the symbols on the OFDM subcarriers are multiplied with the inverse of the channel coefficients and the subcarriers that fade are excluded from the transmissions, known as truncated-channel inversion (TCI) in the literature. In [10], an additional time-varying precoder is applied along with TCI to facilitate the aggregation. In [11], the gradient estimates are sparsified and the sparse vectors are projected into a low-dimensional vector to reduce the bandwidth. The compressed data is transmitted with BAA. In [14], BAA with power control and re-transmissions over static channels is investigated to obtain the optimal number of re-transmissions.

In [15], a multi-slot OAC framework is proposed for fast-fading channels and time diversity is exploited to mitigate the impact of fading channel on OAC. In [16], instead of TCI, the parameters are multiplied with the conjugate of the channel coefficients (i.e., maximum-ratio transmission) to increase the power efficiency. In [17], the channel inversion is optimized with the consideration of sum-power constraint to avoid potential interference issues.

In [12], OBDA is proposed to facilitate the implementation of FEEL for a practical wireless system. In this method, considering distributed training by MV with the signSGD [22], the EDs transmit quadrature phase-shift keying (QPSK) symbols along with TCI, where the real and imaginary parts of the QPSK symbols are formed by using the signs of the stochastic gradients. At the ES, the signs of the real and imaginary components of the superposed received symbols on each subcarrier are calculated to obtain the MV for the sign of each gradient. The authors in also consider OBDA, but the pre-equalization in this method applies only phase correction to the transmitted symbols (i.e., equal-gain transmission) by emphasizing the fact that the amplitude alignment is not needed for digital OAC. The reader is referred to for various combining strategies for channel-aware decision fusion under the assumption of real-valued channel coefficients.

In the literature, there are OAC methods that do not use pre-equalization. For example, in and [27], the authors consider blind EDs, i.e., CSI is not available at the ED. By exploiting channel hardening, the ES utilizes an estimate of the superposed CSI to achieve an analog aggregation with maximum-ratio combining (MRC). Pre-equalization along with digital and analog beamforming are investigated for OAC in and [28], respectively. To address the issues related to TCI, in and [21], the OAC for FEEL is realized by exploiting non-coherent receiver techniques. Similar to OBDA [12], the schemes in and depend on the distributed training based on MV [22]. However, instead of modulating the phase of the OFDM subcarriers based on the sign of the local stochastic gradients, the schemes in and use FSK and PPM, respectively, and a non-coherent detector is used to detect the MV at the ES. While and provide robustness against time-variation of the wireless channel, synchronization errors, and imperfect power control, the 1-bit quantization nature of signSGD can degrade the test accuracy in the heterogeneous data distribution scenarios.

In and [30], Goldenbaum and Stanczak propose to calculate the energy of a sequence of superposed symbols. In [31], they show that their scheme can also work when there is no CSI at the transmitter under a scenario where the ES is equipped with multiple antennas. Nevertheless, the performance of these schemes rely on existence of special set of sequences to reduce the interference across the uses. Another relevant work is Goldenbaum's digital OAC method discussed in [32]. In this method, a general nomographic function is targeted. Lattice coding with a special source encoding is investigated. However, the proposed scheme is only evaluated for additive white Gaussian noise (AWGN) channel.

2) Quantization: In the literature, extensive efforts have been made to decrease the communication costs of machine learning algorithms by quantization. For example, in [33], a general quantized stochastic gradient descent (SGD) (QSGD) with the Elias integer encoding is investigated for encoding the gradients by relying on the fact that large gradients are often less frequent. The signSGD, proposed in [22], is an extreme case of quantization, where the signs of the gradients are considered for the training. In [34], a ternary quantization, which is a balanced number system where the base is 3, is applied to the model parameters to implement FL based on parameter averaging.

In [35], by considering the tradeoff between precision and energy, the quantization levels for the neural network parameters are optimized for FL. In [36], a gradient quantization method that uses the historical gradients as side information to compress the local gradients is proposed. The authors exploits the fact that gradients between adjacent rounds may have a high correlation for SGD. Nevertheless, these quantization methods consider either ideal communication channels for training or orthogonal multiple access for EDs. Also, they do not consider an OAC scheme.

### SUMMARY OF THE PRESENTLY DISCLOSED SUBJECT MATTER

Aspects and advantages of the presently disclosed subject matter will be set forth in part in the following description, or may be apparent from the description, or may be learned through practice of the presently disclosed subject matter.

Broadly speaking, the presently disclosed subject matter relates to improvements in federated edge learning (FEEL) as a distributed learning framework.

Further, this disclosure addresses the communication latency problem of training an artificial intelligence model over a wireless network. It reduces the per-round communication latency. It also paves the way for training when the data distribution is heterogeneous in the network.

More particularly, we presently disclose a digital over-the-air computation (OAC) scheme for achieving continuous-valued (analog) aggregation for distributed machine learning applications in wireless networks, e.g., federated edge learning (FEEL). We show that the average of a set of real-valued parameters can be calculated approximately by using the average of the corresponding numerals, where the numerals are obtained based on a balanced number system. By exploiting this key property, the presently disclosed scheme encodes the local stochastic gradients into a set of numerals. Next, it determines the positions of the activated orthogonal frequency division multiplexing (OFDM) subcarriers by using the values of the numerals. To eliminate the need for precise sample-level time synchronization, channel estimation overhead, and power instabilities due to the channel inversion, the presently disclosed scheme also uses a non-coherent receiver at the edge server (ES) and does not utilize a pre-equalization at the edge devices (EDs). To improve the test accuracy of FEEL with the presently disclosed scheme, we also introduce the concept of adaptive absolute maximum (AAM). Our numerical results show that when the presently disclosed scheme is used with AAM for FEEL, the test accuracy can reach up to 98% for heterogeneous data distribution.

In this disclosure, we introduce an OAC scheme for FEEL, where the local stochastic gradients are encoded into a set of numerals based on a balanced (also called signed-digit) number system to achieve a continuous-valued computation over a digital scheme. To avoid confusion, we use the terms of “numeral” and “balanced” for “digit” and “signed-digit”, respectively, since the term of “digit” may specifically imply the ten symbols of the common base 10 numeral system. The presently disclosed method does not rely on pre-equalization and the availability of channel state information (CSI) at the EDs and the ES, which relaxes the synchronization requirements at the EDs and the ES.

### B. Contributions

Some of the contributions of this presently disclosed subject matter can be listed as follows:

Continuous-valued OAC with a digital scheme: We show that the average of a set of real-valued parameters can be calculated by using the average of the corresponding numerals in the real domain, approximately. By exploiting this key property, discussed in Section III-A, we achieve a continuous valued computation over a digital OAC scheme. With the presently disclosed method, the EDs first encode the real-valued local stochastic gradients into the numerals for a given balanced number system. The EDs then active the dedicated time-frequency resources (i.e., OFDM subcarriers) based on the values of the numerals. The EDs simultaneously transmit their OFDM symbols and the average numerals are calculated at the ES with a non-coherent receiver. By using the average of the numerals, the ES computes an estimate of the real-valued average stochastic gradient. To the best of our knowledge, this is the first disclosure that uses a general balanced number system for OAC.

Theoretical MSE analysis: We derive the mean squared error (MSE) of the estimator of the average stochastic gradient for a given set of parameters such as number of numerals, number of EDs, number of antennas at the ES, and the base in Section III-D. We also introduce the concept of adaptive absolute maximum (AAM), where each ED shares a single parameter with the ES to adjust the maximum quantization level to minimize the estimation error over the communication rounds of FEEL.

Theoretical convergence analysis: By using the MSE derivation and considering both homogeneous and heterogeneous data distributions in the network, we prove the convergence of FEEL in the presence of the presently disclosed scheme with and without AAM for a non-convex loss function, i.e., Theorem 1 and Theorem 2, respectively. While the presently disclosed framework without AAM contributes the noise ball due to the stochastic gradients in an additive manner, the additive impact is removed when the presently disclosed scheme is utilized with the AAM.

Organization: The rest of the disclosure is organized as follows. In Section II, the notation and the preliminary discussions used in the rest of the sections are provided. In Section III, the presently disclosed OAC scheme and its MSE performance are discussed. In Section IV, the convergence rate of the FEEL with the presently disclosed scheme is discussed. In Section V, the numerical results are provided. We conclude the disclosure in Section VI.

Notation: The sets of complex numbers, real numbers, integers, and integers modulo H are denoted by [symbol] , [symbol] , [symbol] , and [symbol] _{H} respectively. The N-dimensional all zero vector and the N×N identity matrix are O_{N} and I_{N}, respectively. The function [symbol] [·] results in 1 if its argument holds, otherwise it is 0. [symbol] ₓ[·] is the expectation of its argument over x. ∇f (w) denotes the gradient of the function f , i.e. ∇f , at the point w. The zero-mean circularly symmetric multivariate complex Gaussian distribution with the covariance matrix C_{M} of an M-dimensional random vector x∈ [symbol] is denoted by x˜CN(0_{M}, C_{M}). The gamma distribution with the shape parameter n and the rate λ is Γ(n, λ). The binomial distribution with the K trials and the success probability p for each trial is [symbol] (K, p). The [symbol] ₂-norm of the vector x is ∥x∥₂. [ [symbol] ] denotes { [symbol] ₀, . . . , [symbol] _{K-1}}.

Yet another aspect of the presently disclosed subject matter is to improve technology areas related to over-the-air computation (OAC) methodology and systems for federated edge learning (FEEL).

One presently disclosed exemplary embodiment relates to a methodology for a over-the-air computation (OAC) methodology for federated edge learning (FEEL) without using pre-equalization or channel state information (CSI) at a plurality of edge devices (EDs) or at an edge server (ES). Such exemplary methodology may preferably comprise providing a distributed machine-learning model to be trained with the update vectors received at an edge server (ES) as transmitted from a plurality of edge devices (EDs); and performing methodology operations comprising. Such operations may preferably comprise transmitting local update vectors as real-valued local stochastic gradients from each respective of the plurality of edge devices (EDs) via a wireless multiple access channel, receiving the superposed local update vectors at the ES, and inputting the superposed local update vectors into the machine-learning model to be updated. Preferably, such real-valued local stochastic gradients are encoded into a set of numerals based on a balanced number system to achieve a continuous-valued computation over a digital scheme.

It is to be understood from the complete disclosure herewith that the presently disclosed subject matter equally relates to both methodology and corresponding and related apparatus/system subject matter.

Another presently disclosed exemplary embodiment preferably relates to a system for an over-the-air computation (OAC) system for federated edge learning (FEEL) without using pre-equalization or channel state information (CSI) at a plurality of edge devices (EDs) or at an edge server (ES). Such exemplary system preferably may comprise a distributed machine-learning model training to process data comprising update vectors received at an edge server (ES) as transmitted from a plurality of edge devices (EDs); one or more processors; and one or more non-transitory computer-readable media that store instructions that, when executed by the one or more processors, cause the one or more processors to perform operations. Such operations preferably comprise transmitting local update vectors as real-valued local stochastic gradients from each respective of the plurality of edge devices (EDs) via a wireless multiple access channel, receiving the superposed local update vectors at the ES, and inputting the superposed local update vectors into the machine-learning model to be updated. Such real-valued local stochastic gradients preferably are encoded into a set of numerals based on a balanced number system to achieve a continuous-valued computation over a digital scheme.

Other example aspects of the present disclosure are directed to systems, apparatus, tangible, non-transitory computer-readable media, user interfaces, memory devices, and electronic smart devices or the like. To implement methodology and technology herewith, one or more processors may be provided, programmed to perform the steps and functions as called for by the presently disclosed subject matter, as will be understood by those of ordinary skill in the art.

Per some presently disclosed embodiments, the presently disclosed scheme achieves a continuous-valued computation over a digital scheme. Hence, it can address a wide range of scenarios including wireless sensor networks. It does not need a channel inversion at the EDs. From this aspect, it is compatible with time-varying channels and does not lose the gradient information due to the truncation. The presently disclosed scheme reduces PMEPR with a simple randomization technique. It also does not require CSIs at the ES or multiple antennas for over-the-air computation. It can also provide a test accuracy when the data distribution is heterogeneous.

Potential market size is large as it is related to both commercial wireless and AI technologies. It could be useful for artificial intelligence technologies over wireless or sensor networks, 5G and beyond, 6G wireless standardization, IEEE 802.11 Wi-Fi. Also, recently, IEEE 802.11 has formed a Topic Interest Group (TIG), where distributed learning over a wireless network has been mentioned (https://mentor.ieee.org/802.11/documents?is_dcn=DCN%2C%20Title%2C%20Author%20or%20Affiliation&is_group=).

Additional objects and advantages of the presently disclosed subject matter are set forth in, or will be apparent to, those of ordinary skill in the art from the detailed description herein. Also, it should be further appreciated that modifications and variations to the specifically illustrated, referred and discussed features, elements, and steps hereof may be practiced in various embodiments, uses, and practices of the presently disclosed subject matter without departing from the spirit and scope of the subject matter. Variations may include, but are not limited to, substitution of equivalent means, features, or steps for those illustrated, referenced, or discussed, and the functional, operational, or positional reversal of various parts, features, steps, or the like.

Still further, it is to be understood that different embodiments, as well as different presently preferred embodiments, of the presently disclosed subject matter may include various combinations or configurations of presently disclosed features, steps, or elements, or their equivalents (including combinations of features, parts, or steps or configurations thereof not expressly shown in the Figures or stated in the detailed description of such Figures). Additional embodiments of the presently disclosed subject matter, not necessarily expressed in the summarized section, may include and incorporate various combinations of aspects of features, components, or steps referenced in the summarized objects above, and/or other features, components, or steps as otherwise discussed in this application. Those of ordinary skill in the art will better appreciate the features and aspects of such embodiments, and others, upon review of the remainder of the specification, and will appreciate that the presently disclosed subject matter applies equally to corresponding methodologies as associated with practice of any of the present exemplary devices, and vice versa.

### BRIEF DESCRIPTION OF THE FIGURES

A full and enabling disclosure of the presently disclosed subject matter, including the best mode thereof, directed to one of ordinary skill in the art, is set forth in the specification, which makes reference to the appended Figures, in which:

FIG. 1 illustrates transmitter and receiver diagrams with the presently disclosed OAC scheme for FEEL;

FIG. 2(a) and FIG. 2(b) graphically illustrate BMSE versus number of antennas for uniform distribution and zero-mean Gaussian distribution with the variance 0.2 for different numbers of β and D (=0.01, vₘₐₓ=1, K=25), with in particular FIG. 2(a) and FIG. 2(b) plots of the BMSE versus number of antennas for the uniform and Gaussian distributions, respectively;

Table 1 is a table of an exemplary presently disclosed a convolution neural network (CNN) at the EDs for practicing the presently disclosed methodology, and listing exemplary layers, learnables, and activations;

FIGS. 3(a) through 3(f) illustrate respective graphs providing various test accuracy results versus communication rounds for the scenario with homogeneous data distribution, with FIG. 3(a) specifically relating to without AAM, and with Momentum: 0, R=1, with FIG. 3(b) specifically relating to with AAM and with Momentum: 0, R=1, with FIG. 3(c) specifically relating to with AAM and with Momentum: 0.9, R=1, with FIG. 3(d) specifically relating to without AAM and with Momentum: 0, R=25, with FIG. 3(e) specifically relating to with AAM and with Momentum: 0, R=25, and with FIG. 3(f) specifically relating to with AAM and with Momentum: 0.9, R=25;

FIGS. 4(a) through 4(f) illustrate respective graphs providing various test accuracy results versus communication rounds for the scenario with highly heterogeneous data distribution (i.e., each ED has only 6 unique digits), FIG. 4(a) specifically relating to without AAM, and with Momentum: 0, R=1, with FIG. 4(b) specifically relating to with AAM and with Momentum: 0, R=1, with FIG. 4(c) specifically relating to with AAM and with Momentum: 0.9, R=1, with FIG. 4(d) specifically relating to without AAM and with Momentum: 0, R=25, with FIG. 4(e) specifically relating to with AAM and with Momentum: 0, R=25, and with FIG. 4(f) specifically relating to with AAM and with Momentum: 0.9, R=25;

FIG. 5(a) and FIG. 5(b) graphically illustrate NMSE versus number of antennas for uniform distribution and zero-mean Gaussian distribution with the variance 0.2 for different numbers of β and D (=0.01, vₘₐₓ=1, K=25), with in particular FIG. 5(a) and FIG. 5(b) plots of the NMSE versus number of antennas for the uniform and Gaussian distributions, respectively;

FIG. 6 graphically illustrates NMSE versus a higher number of antennas for different numbers of β and D;

FIG. 7 graphically illustrates (y-axis) NMSE for different numbers of β and R, versus a range of values of D×(;β−1) over an x-axis; and

FIG. 8 graphically illustrates a step-wise plot of v both with binary with sign and balanced ternary graphing.

Repeat use of reference characters in the present specification and drawings is intended to represent the same or analogous features or elements or steps of the presently disclosed subject matter.

### DETAILED DESCRIPTION OF THE PRESENTLY DISCLOSED SUBJECT MATTER

It is to be understood by one of ordinary skill in the art that the present disclosure is a description of exemplary embodiments only, and is not intended as limiting the broader aspects of the disclosed subject matter. Each example is provided by way of explanation of the presently disclosed subject matter, not limitation of the presently disclosed subject matter. In fact, it will be apparent to those skilled in the art that various modifications and variations can be made in the presently disclosed subject matter without departing from the scope or spirit of the presently disclosed subject matter. For instance, features illustrated or described as part of one embodiment can be used with another embodiment to yield a still further embodiment. Thus, it is intended that the presently disclosed subject matter covers such modifications and variations as come within the scope of the appended claims and their equivalents.

The present disclosure is generally directed to improvements in federated edge learning (FEEL) as a distributed learning framework.

### II. Preliminaries and System Model

More particularly, in this section, we provide the signal and learning model that we use throughout the disclosure and the preliminaries related to the encoding and decoding based on a balanced number system.

### A. Signal Model

We consider a wireless network with K EDs that are connected to an ES, where each ED and the ES are equipped with a single antenna and R antennas, respectively. We assume that the large-scale impact of the wireless channel is compensated with a power control mechanism, e.g., closed-loop power control with physical uplink control channel (PUCCH) in Fifth Generation (5G) New Radio (NR) [37], before the training process for FEEL begins.

For the signal model, we assume that the EDs access the wireless channel on the same time-frequency resources simultaneously with S OFDM symbols consisting of M active subcarriers for OAC. Assuming that the cyclic prefix (CP) duration is larger than the sum of maximum time-synchronization error and maximum-excess delay of the channel, we express the superposed modulation symbol on the lth subcarrier of the mth OFDM symbol at the ES for the [symbol] th communication round of the training as:

$${r}_{l , m}^{( ℓ )} = {\sum }_{k = 0}^{K - 1} {h}_{k , l , m}^{( ℓ )} {t}_{k , l , m}^{( ℓ )} + {n}_{l , m}^{( ℓ )} , \qquad ( 1 )$$

where h_{k,l,m}⁽ [symbol] ⁾˜ [symbol] (0_{R},I_{R}) is a vector that consists of the channel coefficients between R antennas at the ES and the kth ED, th_{k,l,m}⁽ [symbol] ⁾∈ [symbol] is the transmitted modulation symbol from the kth ED, and n_{l,m}⁽ [symbol] ⁾ ˜ [symbol] (0_{R},σₙ²I_{R}) is the AWGN, where σₙ² is the noise variance for l∈ [symbol] _{M}and m∈ [symbol] _{S}.

We denote the signal-to-noise ratio (SNR) of an ED at the ES receiver as 1/σₙ².

In practice, the synchronization point where the discrete Fourier transform (DFT) starts to be applied to the received signal for demodulation at the ES and the time synchronization across the EDs may not be precise. To model former impairment, we assume that synchronization point can deviate by Nₑᵣᵣ samples within the CP window. For the latter impairment, the time of arrivals of the EDs' signals at the ES location are sampled from a uniform distribution between 0 and T_{sync} seconds, where T_{sync} is equal to the reciprocal to the signal bandwidth. Note the coarse time-synchronization can be maintained with the state-of-the-art protocols used in cellular systems. We introduce additional phase rotations to h_{k,l,m}⁽ [symbol] ⁾ to capture the impact of the time-synchronization errors on r_{l,m}⁽ [symbol] ⁾. We assume that the frequency synchronization is handled before the transmissions with a control mechanism as done in 3GPP Fourth Generation (4G) Long Term Evolution (LTE) and/or 5G NR with random-access channel (RACH) and/or PUCCH or custom methods such as AirShare [39].

### B. Quantization and Balanced Number Systems

Let ƒ_{enc,β} be a function that maps v∈ [symbol] to a sequence of D elements (i.e., numerals) in {(X_{D-1}, . . . , x_{1,} x₀) |xᵢ∈ [symbol] _{β}, β>1, i∈ [symbol] _{D}} as

(x_{D-1}, . . . , x₁,x₀)=ƒ_{enc,β}(v), (2)

where β is the base (also called scale [40]), xᵢ is referred to as a numeral at the ith position, and S_{β} is the symbol set with base β.

In this disclosure, we consider a balanced number system for expressing _{enc,β} and assume that β is an odd positive integer. The numerals are obtained as follows: For a given v for |v|≤vₘₐₓ, the encoder ƒ_{enc,β} (v) first computes the base-β representation of the rounded, biased, and normalized v as:

$$⌊ \frac{ξ}{{v}_{max}} v + ξ + \frac{1}{2} ⌋ {=}^{△} {\sum }_{i = 0}^{D - 1} {b}_{i} {β}^{i} , \qquad ( 3 )$$

for ξ [symbol] (β^{D}−1)/2 and bᵢ∈ [symbol] _{β}.

Afterwards, it calculates xᵢ as xᵢ [symbol] bᵢ−(β−1)/2, ∀i∈ [symbol] _{D}. Hence, [symbol] _{β} can be defined as:

[symbol]

_{β} [symbol] {aⱼ|aⱼ=ƒ_{bal}(j), j∈ [symbol] _{β}}, (4)

where ƒ_{bal} (j) is given by

$${f}_{bal} ( j ) {=}^{△} \{ \begin{matrix}- ( j + 1 ) / 2 , & odd j , j < β - 1 \\ ( j + 2 ) / 2 , & even j , j < β - 1 \\ 0 , & j = β - 1\end{matrix} . \qquad ( 5 )$$

Based on (5), a_{β-1} is a zero-valued symbol. The example symbol sets for β=5 and β=7 can obtained as [symbol] ₅={−1, 1, −2, 2, 0} and [symbol] ₇={−1, 1, −2, 2, −3, 3, 0}, respectively. For a balanced number system, there is no dedicated symbol for the sign of v as [symbol] _{β} contains negative-valued symbols.

### EXAMPLE 1

Assume that β=5, D=3, and vₘₐₓ=1 and we want to calculate ƒ_{enc,β}(0.28) and ƒ_{enc,β}(−0.86). By the definition, ξ=(5²1)/2=62. The base 5 representations of the decimal └62×−0.86+62+½┘=79 and the decimal └62×−0.86+62+½┘=9 are (b₂b₁b₀)₅=(304)₅ and (b₂b₁b₀)₅=(014)₅, respectively. Since xᵢ [symbol] bᵢ−(β−1)/2, we obtain ƒ_{enc,β}(0.28)=(1, −2, 2), and ƒ_{enc,β}(−0.86)=(−2, −1, 2).

The corresponding decoder ƒ_{dec,β} that maps the sequence (x_{D-1} , . . . , x₁, x₀) to v̅∈ [symbol] can be expressed as:

$$\overline{v} = {f}_{dec , β} ( {x}_{D - 1} , … , {x}_{1} , {x}_{0} ) {=}^{△} \frac{{v}_{max}}{ξ} {\sum }_{i = 0}^{D - 1} {x}_{i} {β}^{i} . \qquad ( 6 )$$

Note that v̅=ƒ_{enc,β}ƒ_{dec,β}(v) forms a mid-tread uniform quantization, i.e., zero is one of the re-construction levels. The quantization step size can also be calculated as Δ=2vₘₐₓ/(β_{D-1} ) and the quantization error, i.e., |v−v̅|, decreases with increasing D for |v|≤vₘₐₓ.

### EXAMPLE 2

Consider the parameters given in Example 1. Hence, we obtain ƒ_{dec,β}ƒ_{enc,β}(0.28)=ƒ_{dec,β}(1, −2, 2)≈0.2742, and ƒ_{dec,β}ƒ_{enc,β}(−0.86)=ƒ_{dec,β}(−2, −1, 2)≈−0.8548 based on (6). The step size can also be calculated as Δ=2/(5³−1)≈0.016.

### C. Learning Model

Let [symbol] ₖ denote the local data set containing the labeled data samples ( [symbol] , [symbol] ) at the kth ED, ∀k∈ [symbol] _{K}K, where [symbol] is the [symbol] th data sample with its ground truth label [symbol] . Suppose that all EDs upload their data sets to the ES. The centralized learning problem can then be expressed as:

$${w}^{*} = arg {min}_{w ∈ {Q}^{}} F ( w ) = arg {min}_{w ∈ {Q}^{}} \frac{1}{\vert \vert} {\sum }_{∀ ( {x}_{ℓ} , {y}_{ℓ} ) ∈} f ( w ; {x}_{ℓ} , {y}_{ℓ} ) , \qquad ( 7 )$$

where F(w) is the loss function, [symbol] = [symbol] ₀∪ [symbol] ₁∪ . . . ∪ [symbol] _{K-1} is complete data set, and ƒ (w; [symbol] , [symbol] ) is the sample loss function for the parameters w=[w₀, . . . , w_{Q-1}]^{T}∈ [symbol] , and Q is the number of parameters.

With (full-batch) gradient descent, a local optimum point can be obtained as:

w⁽ [symbol] ⁺ [symbol] ⁾=w⁽ [symbol] ⁾−ηg⁽ [symbol] ⁾, (8)

where η is the learning rate and the gradient vector g⁽ [symbol] ^{)=[g}₀⁽ [symbol] ⁾, . . . , g_{Q-1}⁽ [symbol] ⁾]^{T}∈ [symbol] be expressed as:

$${g}^{( ℓ )} = ∇ F ( {w}^{( ℓ )} ) = \frac{1}{\vert \vert} {\sum }_{∀ ( {x}_{ℓ} , {y}_{ℓ} ) ∈} ∇ f ( {w}^{( ℓ )} ; {x}_{ℓ} , {y}_{ℓ} ) . \qquad ( 9 )$$

The equation (8) can be re-written as:

$$\begin{matrix}{w}^{( ℓ + 1 )} = {w}^{( ℓ )} - η {\sum }_{k = 0}^{K - 1} \frac{\vert {k}_{} \vert}{\vert \vert} {\underbrace{\frac{1}{\vert {k}_{} \vert} {\sum }_{∀ ( {x}_{ℓ} , {y}_{ℓ} ) ∈ {k}_{}} ∇ f ( {w}^{( ℓ )} ; {x}_{ℓ} , {y}_{ℓ} )}}_{{=}^{△} {g}_{k}^{( ℓ )}} \\ = {\sum }_{k = 0}^{K - 1} \frac{\vert {k}_{} \vert}{\vert \vert} ( {w}^{( ℓ )} - η {g}_{k}^{( ℓ )} )\end{matrix} ,$$

where gₖ⁽ [symbol] ⁾∈ [symbol] denotes the local gradient vector at the kth ED.

Therefore, (8) can still be realized by communicating the local gradients or locally updated model parameters between the EDs and the ES, rather than moving the local data sets from the EDs to the ES, which is beneficial for promoting data privacy [5], [8]. This observation also shows the underlying principle of the plain FL based on gradient or model parameter aggregations [7].

FEEL aims to realize FL over a wireless network. In this disclosure, we consider the implementation of FL based on SGD, known as FedSGD [7], over a wireless network: The kth ED calculates an estimate of the local gradient vector, denoted by \tilde{g}ₖ⁽ [symbol] ⁾=[\tilde{g}_{k,0}⁽ [symbol] ⁾ , . . . , \tilde{g}_{k,Q-1}⁽ [symbol] ⁾]^{T}∈ [symbol] ,as:

$${\tilde{g}}_{k}^{( ℓ )} = ∇ {F}_{k} ( {w}^{( ℓ )} ) = \frac{1}{{n}_{b}} {\sum }_{∀ ( {x}_{ℓ} , {y}_{ℓ} ) ∈ {k}_{}} ∇ f ( {w}^{( ℓ )} ; {x}_{ℓ} , {y}_{ℓ} ) , \qquad ( 10 )$$

where [symbol] ⊂ [symbol] is the data batch obtained from the local data set and n_{b}=| [symbol] ₖ| as the batch size

The EDs transmit the local gradient estimates to the ES. Assuming identical data set sizes across the EDs, to solve (7), the ES calculates the average stochastic gradient vector

$${v}^{( t )} {=}^{△} {[ {v}_{0}^{( ℓ )} , … , {v}_{Q - 1}^{( ℓ )} ]}^{T} = \frac{1}{K} {\sum }_{k = 0}^{K - 1} {\tilde{g}}_{k}^{( ℓ )}$$

and broadcasts it to the EDs. Finally, the model parameters at the EDs are updated as:

w⁽ [symbol] ^{+1 )}=w⁽ [symbol] ⁾−ηV⁽ [symbol] ⁾. (11)

With a traditional orthogonal user multiplexing, the per-round communication latency for FEEL linearly increases with the number of EDs [41]. With the motivation of eliminating per-round communication latency, the main objective of this work is to calculate an estimate of v⁽ [symbol] ⁾, denoted by \hat{v}⁽ [symbol] ⁾ [symbol] [\hat{v}₀⁽ [symbol] ⁾ , . . . , \hat{v}_{Q-1}⁽ [symbol] ⁾]^{T}, through a digital OAC scheme robust against fading channel.

### III. Presently Disclosed OAC Scheme

In this section, we discuss the presently disclosed OAC scheme relying on the representation of the gradients based on a balanced number system. We analyze its performance in terms of MSE and introduce the AAM to improve the MSE over the communication rounds of FEEL.

### A. Key Observation

Based on the discussions given in Section II-C, consider the qth gradient at the kth ED for the [symbol] th communication round of the FEEL, i.e., \tilde{g}_{k,q}⁽ [symbol] ⁾. Suppose that \tilde{g}_{k,q}⁽ [symbol] ⁾is encoded into the sequence of length D denoted by:

(d_{k,qD-1}⁽ [symbol] ⁾,. . . , d_{k,q,l} ⁽ [symbol] ⁾d_{k,q,0}⁽ [symbol] ⁾)=ƒ_{enc,β}(\tilde{g}_{k,q}⁽ [symbol] ⁾). (12)

for d( [symbol] ) k,q,i∈Sβ.

By using definition of ƒ_{dec,β} in (6), the qth average stochastic gradient, i.e.,

$${v}_{q}^{( ℓ )} = \frac{1}{K} {{\sum }_{k = 0}}^{K - 1} {\tilde{g}}_{k , q}^{( ℓ )}$$

can be obtained approximately as:

$${v}_{q}^{( ℓ )} \underline{\approx } {\overline{v}}_{q}^{( ℓ )} {△}_{=} \frac{1}{K} {{\sum }_{k = 0}}^{K - 1} {{g}^{\overline{\sim}}}_{k , q}^{( ℓ )} = \frac{{v}_{max}}{ξ} {{\sum }_{i = 0}}^{D - 1} {\underbrace{\frac{1}{K} {{\sum }_{k = 0}}^{K - 1} {d}_{k , q , i}^{( ℓ )}}}_{{△}_{=} {μ}_{q , i}^{( ℓ )}} {β}^{i} = {f}_{dec , β} ( {μ}_{q , D - 1}^{( ℓ )} , … , {μ}_{q , 1}^{( ℓ )} , {μ}_{q , 0}^{( ℓ )} ) , \qquad ( 13 )$$

where \tilde{g̅}_{k,q}⁽ [symbol] ⁾is the quantized gradient, i.e., \tilde{g̅}_{k,q}⁽ [symbol] ⁾=ƒ_{dec,β}ƒ_{enc,β}(\tilde{g}_{k,q}⁽ [symbol] ⁾).

Equation (13) implies that v_{q}⁽ [symbol] ⁾ can be calculated approximately by evaluating the function ƒ_{dec,β} with the values that are calculated by averaging the numerals across K EDs in real domain, i.e., {μ_{g,i}⁽ [symbol] ⁾|i∈ [symbol] _{D}˜}. By evaluationg μ_{q,i}^{(t)}further, it can also be shown that:

$${μ}_{q , i}^{( ℓ )} = \frac{1}{K} {{\sum }_{k = 0}}^{K - 1} {d}_{k , q , i}^{( ℓ )} = \frac{1}{K} {{\sum }_{j = 0}}^{β - 1} {a}_{j} {U}_{q , i , j} , \qquad ( 14 )$$

where U_{q,i,j} denotes the number of EDs with the symbol aⱼ for the ith numeral in (12) and the qth gradient.

Note that the identity in (14) is due to the definition of expectation for discrete outcomes as given for a probability mass function.

### EXAMPLE 3

Assume that K=2, \tilde{g}_{0,q}⁽ [symbol] ⁾=0.28, and \tilde{g}_{1,q}⁽ [symbol] ⁾=−0.86. The average of the gradients can be calculated as v_{q}⁽ [symbol] ⁾=(\tilde{g}_{0,q}⁽ [symbol] ⁾+\tilde{g}_{1,q}⁽ [symbol] ⁾)=−0.29. Now, consider the encoder parameters given in Example 1. We obtain ƒ_{enc,β}(0.28)=(1, −2, 2), and ƒ_{enc,β}(−0.86)=(−2, −1, 2). Therefore, the average of the numerals can be calculated as (μ_{q,2}⁽ [symbol] ⁾, μ_{q,1}⁽ [symbol] ⁾, μ_{q,0}⁽ [symbol] ⁾)=(1−2, −2−1, 2+2)/2=(−½, − 3/2, 2). Also, notice that (μ_{q,2}⁽ [symbol] ⁾, μ_{q,1}⁽ [symbol] ⁾, μ_{q,0}⁽ [symbol] ⁾) can be calculated by using the number of EDs that votes for each element of {−1, 1, −2, 2, 0}. For instance, μ_{q,0}⁽ [symbol] ⁾ can be calculated via the last expression in (14) for (U_{q,i,0}, U_{q,i,1}, U_{q,i,2}, U_{q,i,3}, U_{q,i,4})=(0, 0, 0, 2, 0) where the corresponding symbols are (a₀, a₁, a₂, a₃, a₄)=(−1, 1, −2, 2, 0) for β=5. By evaluating v̅_{q}⁽ [symbol] ⁾=ƒ_{dec,β}(−½, − 3/2, 2), we obtain v̅_{q}⁽ [symbol] ⁾≈−0.2903. Note v̅_{q}⁽ [symbol] ⁾ is also equal to the average of the quantized gradients, i.e., ƒ_{dec,β}ƒ_{enc,β}(0.28)≈0.2742 and ƒ_{dec,β}ƒ_{enc,β}(−0.86) ≈−0.8548, as exemplified in Example 2.

The presently disclosed OAC scheme computes an estimate of v̅_{q}⁽ [symbol] ⁾ by relying on the expansion in (13) and the identity given in (14), rather than averaging the continuous \tilde{g}_{k,q}⁽ [symbol] ⁾ with an analog OAC such as BAA proposed in [9].

### B. Edge Device—Transmitter

At the [symbol] th communication round of the FEEL, the kth ED calculates the numerals {d_{k,q,i}⁽ [symbol] ⁾|q∈ [symbol] _{Q},i∈ [symbol] _{D}} with (12), for a given β. The main strategy exploited at the kth ED with the presently disclosed scheme is that β−1 subcarriers are dedicated for each numeral and one of them is activated based on its value. To express this encoding operation rigorously, let [symbol] be a function that maps q∈ [symbol] _{Q} to a set of (β−1)D distinct time-frequency index pairs denoted by T_{q} [symbol] {(m_{i,} [symbol] , lᵢ [symbol] )|i∈ [symbol] _{D}, [symbol] ∈ [symbol] _{β-1}} for m_{i,} [symbol] ∈ [symbol] ₛ and lᵢ [symbol] ∈ [symbol] _{M}, where [symbol] _{q1}∩ [symbol] _{q2}=∅if q₁≠q₂ for q₁, q₂Å [symbol] _{Q}. The kth ED determines the modulation symbol t_{k,m}_{ᵢ}_{,} [symbol] _{,l}_{ᵢ}_{,} [symbol] ⁽ [symbol] ⁾ as:

$${t}_{k , {m}_{i , ℓ} , {l}_{i , ℓ}} = \sqrt{{E}_{s}} {s}_{k , q , i}^{( ℓ )} ⨯ 𝕀 [ {d}_{k , q , i}^{( ℓ )} = {a}_{ℓ} ] . \qquad ( 15 )$$

for all i∈ [symbol] _{D} and [symbol] ∈ [symbol] _{β-1}, where Eₛ=β−1 is a factor to normalize the OFDM symbol energy and s_{k,q,l}⁽ [symbol] ⁾ is a randomization symbol on the unit circle for peak-to-mean envelope power ratio (PMEPR) reduction [20].

Note that we do not allocate a subcarrier for a_{β-1}=0 since it does not contribute to the sum given in (14). After the calculation of (15) for all gradients, the kth ED calculates the OFDM symbols and all EDs transmit them simultaneously based on the discussions in Section II. Since the presently disclosed scheme uses (β−1)D subcarriers for each gradient, the maximum number of gradients that can be transmitted on each OFDM symbol can be calculated as Mₚₐᵣ=└M/((β−1)D)┘ for all EDs.

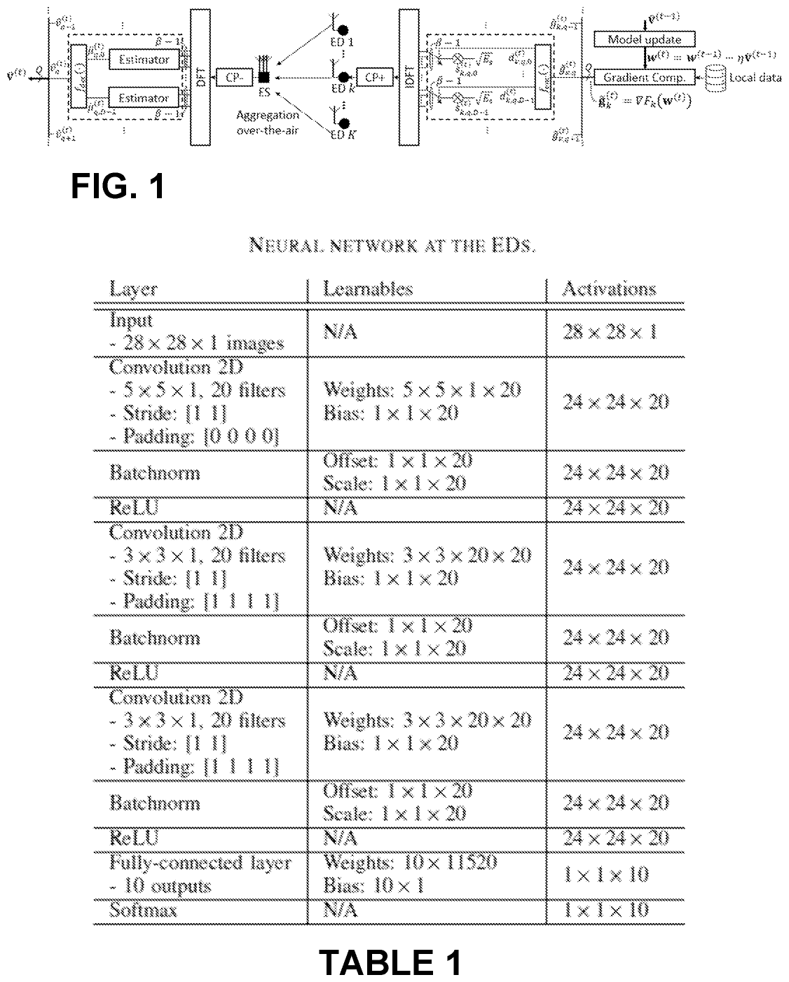

It is worth emphasizing that the function [symbol] can be designed based on an scrambler to randomize the synthesized OFDM symbols or an encryption function to enhance the security of the OAC. We leave these extensions for future work and assume that the function [symbol] uses (β−1)D adjacent subcarriers for each gradient, as illustrated in FIG. 1. In addition, we do not use TCI to compensate the impact of multipath channel on the transmitted symbols as this is beneficial to eliminate: 1) the need for precise time synchronization, 2) the channel estimation overhead in a mobile wireless networks, 3) the information loss due to the truncation, and 4) the power instabilities in fading channel due to the channel inversion. Our scheme also relies on a non-coherent receiver as discussed in Section III-C.

### EXAMPLE 4

Consider the parameters given in Example 3, i.e., K=2, \tilde{g}_{0,q}⁽ [symbol] ⁾=0.28, and \tilde{g}_{1,q}⁽ [symbol] ⁾=−0.86, where the local gradients are represented as ƒ_{enc,β}(0.28)=(d_{0,q,2}⁽ [symbol] ⁾,d_{0,q,1}⁽ [symbol] ⁾,d_{0,q,0}⁽ [symbol] ⁾)=(1, −2, 2) for the 0th ED, and ƒ_{enc,β}(−0.86)=(d_{1,q,2}⁽ [symbol] ⁾,d_{1,q,1}⁽ [symbol] ⁾,d_{1,q,0}⁽ [symbol] ⁾)=(−2, −1, 2) for the 1st ED for β=5 and D=3. Assume that the resource set for the qth gradient, i.e., Tq, is given by:

[symbol]

_{q}={(m_{0,0}, l_{0,0}), (m_{0,1}, l_{0,1}), (m_{0,2}, l_{0,2}), (m_{0,3}, l_{0,3}), (l_{1,0}, l_{1,0}), (m_{1,1}, l_{1,1}), (m_{1,2}, l_{1,2}), (m_{1,3}, l_{1,3}), (m_{2,0}, l_{2,0}), (m_{2,1}, l_{2,1}), (m_{2,2}, l_{2,2}), (m_{2,3}, l_{2,3}),}={(0, 0), (0, 1), . . . , (0, 11)},
i.e., the first 12 adjacent subcarriers of 0th OFDM symbol. Based on (4), [symbol] ₅={a₀=−1, a₁=1, a₂=−2, a₃=2, a₄=0}.

Hence, based on (15), the activated subcarriers for the 0th ED (with omitting the randomization symbols for readability) are then:

$$( {t}_{0 , 0 , 0}^{( ℓ )} , … , {t}_{0 , 0 , 11}^{( ℓ )} ) = {( \underbrace{0 , 0 , 0 , \sqrt{{E}_{s}}}}_{i = 0} , {\underbrace{0 , 0 , \sqrt{{E}_{s}} , 0 ,}}_{i = 1} {\underbrace{0 , \sqrt{{E}_{s}} 0 , 0 )}}_{i = 2} ,$$

because [symbol] [d_{0,q,1}⁽ [symbol] ⁾=a [symbol] ]=1 for (i=0, [symbol] =3), (i=1, [symbol] =2), (i=2, [symbol] =1).

For the 1st ED, the active subcarriers are given by:

$$( {t}_{0 , 0 , 0}^{( ℓ )} , … , {t}_{0 , 0 , 11}^{( ℓ )} ) = {( \underbrace{0 , 0 , 0 , \sqrt{{E}_{s}}}}_{i = 0} , {\underbrace{0 , 0 , \sqrt{{E}_{s}} , 0 ,}}_{i = 1} {\underbrace{0 , \sqrt{{E}_{s}} 0 , 0 )}}_{i = 2} ,$$

as [symbol] [d_{0,q,1}⁽ [symbol] ⁾=a [symbol] ]=1 for (i=0, [symbol] =0), (i=1, [symbol] =2), (i=2, [symbol] =2).

Remark 1. If D=1, the presently disclosed scheme divides [−vₘₐₓ, vₘₐₓ] into β equal ranges and the modulation is equivalent to (β−1)-ary FSK.

### C. Edge Server—Receiver

At the ES, we assume that the CSI, i.e., {h_{k,l,m}⁽ [symbol] ⁾|^{k}∈ZK, l∈ZM, m∈ZS}, is not available. Hence, the ES exploits that rₘ_{ᵢ}_{,} [symbol] _{,l}_{ᵢ}_{,} [symbol] ⁽ [symbol] ⁾ is a random vector for rₘ_{ᵢ}_{,} [symbol] _{,l}_{ᵢ}_{,} [symbol] ⁽ [symbol] ⁾˜ [symbol] (0_{R}, (EₛU_{q,i} [symbol] +σₙ²)I_{R}) and obtains an estimate of {U_{q,i,} [symbol] | [symbol] ∈ [symbol] _{β-1}}, non-coherently. For given i and q, by using the corresponding log-likelihood function, the maximum likelihood (ML) detector can be expressed as:

$$\{ {\hat{U}}_{q , i , ℓ} \vert ℓ ∈ {ℤ}_{β - 1} \} = arg {min}_{\{ {U}_{v ℓ} \}} \{ {{\sum }_{ℓ = 0}}^{β - 2} ln det {Σ}_{ℓ} + {x}_{ℓ}^{H} {Σ}_{ℓ}^{- 1} {x}_{ℓ} \}$$

$$s . t . {U}_{ℓ} ∈ \{ 0 , … , K \} , ℓ ∈ {ℤ}_{β - 1} , {{\sum }_{ℓ = 0}}^{β - 2} {U}_{ℓ} \leq K ,$$

$$where {x}_{ℓ} = {[ ℜ {\{ {r}_{{m}_{i , ℓ} , {l}_{i , ℓ}} \}}^{T} ]}^{T} and {Σ}_{ℓ} = \frac{{E}_{s} {U}_{ℓ} + {σ}_{0}^{2}}{2} {𝕀}_{2 R} .$$

However, due to the constraints, a solution to (16) can increase the receiver complexity considerably. To address this issue, we relax the constraints and evaluate Û_{q,i} [symbol] independently as given by:

$$\begin{matrix}{\hat{U}}_{q , i , ℓ} = arg {min}_{{U}_{ℓ}} \{ 2 R ln ( \frac{{E}_{s} {U}_{ℓ} + {σ}_{n}^{2}}{2} ) + \frac{2 {‖ {r}_{i , ℓ}^{( ℓ )} , {l}_{i , ℓ} ‖}_{2}^{2}}{{E}_{s} {U}_{ℓ} + {σ}_{n}^{2}} \} \\ = \frac{{‖ {r}_{i , ℓ}^{( ℓ )} , {l}_{i , ℓ} ‖}_{2}^{2}}{{E}_{s} R} - \frac{{σ}_{n}^{2}}{{E}_{s}}\end{matrix} . \qquad ( 17 )$$

Therefore, a low-complexity estimator ofμ_{q,i}⁽ [symbol] ⁾ can be obtained as:

$${\hat{μ}}_{q , i}^{( ℓ )} = \frac{1}{K} {{\sum }_{ℓ = 0}}^{β - 2} {a}_{ℓ} {\hat{U}}_{q , i , ℓ} . \qquad ( 18 )$$

Finally, the estimator of v_{q}⁽ [symbol] ⁾ can be expressed as:

\hat{v}_{q}⁽ [symbol] ⁾=ƒ_{dec,β}(\hat{μ}_{q,D-1}⁽ [symbol] ⁾, . . . , \hat{μ}_{q,1}⁽ [symbol] ⁾, \hat{μ}_{q,0}⁽ [symbol] ⁾). (19)

The ES then transmits \hat{v}⁽ [symbol] ⁾ to the EDs for the next communication round and the kth ED updates its parameters as w⁽ [symbol] ⁺¹⁾=w [symbol] ⁾−μ\hat{v}⁽ [symbol] ⁾, ∀k.

The transmitter and received diagrams with the presently disclosed OAC scheme for FEEL based on the aforementioned discussions are provided in FIG. 1.

### D. MSE Analysis

The variable ∥rₘ_{ᵢ}_{,} [symbol] _{,l}_{ᵢ}_{,} [symbol] ⁽ [symbol] ⁾∥₂²/R in (17) is the average of R exponential variables with the mean EₛU_{q,i,} [symbol] +σₙ². Thus, the distribution of ∥rₘ_{ᵢ}_{,} [symbol] _{,l}_{ᵢ}_{,} [symbol] ⁽ [symbol] ⁾∥₂²/R is Γ(R, R/(EsUq,i, [symbol] +σ2n)).

As a result, the mean and the variance of the estimator Û_{q ,i,} [symbol] can be calculated through the properties of a gamma distribution as:

$$𝔼 [ {\hat{U}}_{q , i , ℓ} ] = \frac{𝔼 [ {‖ {r}_{{m}_{i , ℓ} , {l}_{i , ℓ}}^{( ℓ )} ‖}_{2}^{2} / R ]}{{E}_{s}} - \frac{{σ}_{n}^{2}}{{E}_{s}} = {U}_{q , i , ℓ} , and \qquad ( 20 )$$

$$var ( {\hat{U}}_{q , i , ℓ} ) = \frac{var ( {‖ {r}_{{m}_{i , ℓ} , {l}_{i , ℓ}}^{( ℓ )} ‖}_{2}^{2} / R ]}{{E}_{s}} = \frac{1}{R} {( {U}_{q , i , ℓ} + \frac{{σ}_{n}^{2}}{{E}_{s}} )}^{2} , \qquad ( 21 )$$

respectively, where the expectation is calculated over the randomness of the channel and noise.

Hence, Û_{q ,i,} [symbol] is an unbiased estimator. Also, based on (18) and (19), both \hat{μ}_{q,i}⁽ [symbol] ⁾ and \hat{v}_{q}⁽ [symbol] ⁾ are unbiased estimators of μ_{q,i}⁽ [symbol] ⁾and v̅_{q}⁽ [symbol] ⁾, respectively. For a given {U_{q,i,} [symbol] | [symbol] ∈ [symbol] _{β-1}}, by using (18) and (21), the variance of the estimator \hat{μ}_{q,i}⁽ [symbol] ⁾ is obtained as:

$$var ( {\hat{μ}}_{q , i}^{( ℓ )} ) = \frac{1}{R {K}^{2}} {{\sum }_{ℓ = 0}}^{β - 2} {{a}_{ℓ}^{2} ( {U}_{q , i , ℓ} + \frac{{σ}_{n}^{2}}{{E}_{s}} )}^{2} . \qquad ( 22 )$$

Therefore, we can calculate the variance of the estimator \hat{v}_{q}⁽ [symbol] ⁾ as:

$$var ( {\hat{v}}_{q}^{( ℓ )} ) = \frac{{v}_{max}^{2}}{{ξ}^{2} R {K}^{2}} {{\sum }_{i = 0}}^{D - 1} {{\sum }_{ℓ = 0}}^{β - 2} {{a}_{ℓ}^{2} ( {U}_{q , i , ℓ} + \frac{{σ}_{n}^{2}}{{E}_{s}} )}^{2} {β}^{2 i} . \qquad ( 23 )$$

Hence, the (classical) MSE of the estimator \hat{v}_{q}⁽ [symbol] ⁾ can be obtained as:

$$M S E ( {\hat{v}}_{q}^{( ℓ )} ) = \frac{{v}_{max}^{2}}{{ξ}^{2} R {K}^{2}} {{\sum }_{i = 0}}^{D - 1} {{\sum }_{ℓ = 0}}^{β - 2} {{a}_{ℓ}^{2} ( {U}_{q , i , ℓ} + \frac{{σ}_{n}^{2}}{{E}_{s}} )}^{2} {β}^{2 i} + {\underbrace{\frac{1}{{K}^{2}} {( {{\sum }_{k = 0}}^{K - 1} {{g}^{\overline{\sim}}}_{k , q}^{( ℓ )} - {\tilde{g}}_{k , q}^{( ℓ )} )}^{2}}}_{{( {v}_{q}^{( ℓ )} - {\overline{v}}_{q}^{( ℓ )} \_ )}^{2}} ,$$

where the last term is the squared bias due to the quantization.

To derive the Bayesian MSE (BMSE) of the estimator \hat{v}_{q}⁽ [symbol] ⁾ , we assume that the distribution of \tilde{g}_{k,q}⁽ [symbol] ⁾is uniform between −vₘₐₓ−Δ/2 and vₘₐₓ+Δ/2. This implies that the distribution of U_{q ,i,} [symbol] is [symbol] (K, 1/β). As a result, the variance of the error due to the communication channel can be calculated as:

$${σ}_{channel}^{2} \underline{\underline{△}} {𝔼}_{{\overline{v}}_{q}^{( ℓ )}} ⌊ {( {\hat{v}}_{q}^{( ℓ )} - {\overline{v}}_{q}^{( ℓ )} )}^{2} ⌋ = \frac{{v}_{max}^{2}}{{ξ}^{2} R {K}^{2}} {{\sum }_{i = 0}}^{D - 1} {{\sum }_{ℓ = 0}}^{β - 2} {a}_{ℓ}^{2} {𝔼}_{{U}_{q , i , t}} [ {( {U}_{q , i , ℓ} + \frac{{σ}_{n}^{2}}{{E}_{s}} )}^{2} ] {β}^{2 i} \qquad ( 24 )$$

$$= {v}_{max}^{2} {\underbrace{\frac{1}{3 R} ( \frac{1}{β} {( 1 + \frac{{βσ}_{n}^{2}}{K ( β - 1 )} )}^{2} + \frac{β}{K ( β - 1 )} ) \frac{{β}^{D} + 1}{{β}^{D} - 1}}}_{{E}_{channel}} , \qquad ( 25 )$$

by using (23), Eₛ=β−1, and the identities given by:

$${{U}_{q , i , ℓ}}_{} [ {( {U}_{q , i , ℓ} + \frac{{σ}_{n}^{2}}{{E}_{s}} )}^{2} ] = \frac{{K}^{2}}{{β}^{2}} + K ( \frac{β - 1}{{β}^{2}} + \frac{2}{β} \frac{{σ}_{n}^{2}}{{E}_{s}} ) + \frac{{σ}_{n}^{4}}{{E}_{s}^{2}} , \\ \frac{1}{{ξ}^{2}} {\sum }_{i = 0}^{D - 1} {β}^{2 i} = \frac{4}{{β}^{2} - 1} \frac{{β}^{D} + 1}{{β}^{D} - 1} , \\ {\sum }_{ℓ = 0}^{B - 2} {a}_{ℓ}^{2} = \frac{( β - 1 ) β ( β + 1 )}{12} .$$

Since we assume that d_{k,q,i}⁽ [symbol] ⁾ follows a uniform distribution, we can also calculate the quantization error as:

$${σ}_{quan}^{2} {=}^{△} {{v}_{q}^{( ℓ )}}_{} [ {( {\overline{v}}_{q}^{( 𝓉 )} - {v}_{q}^{( 𝓉 )} )}^{2} ] = {v}_{max}^{2} {\underbrace{\frac{1}{3 {K ( {β}^{D} - 1 )}^{2}}}}_{{E}_{quan}} . \qquad ( 26 )$$

Therefore, the BMSE can be calculated as:

BMSI (\hat{v}_{q}⁽ [symbol] ⁾ )=σ_{channel}²+σ_{quan}²=vₘₐₓ²Eₜₒₜₐₗ. (2)

where Eₜₒₜₐₗ is E_{channel}+E_{quan}.

In practice, the gradients often have an unknown probability distribution that

changes over the communication rounds [13]. Hence, the expression in (27) has its own limitation due to the underlying distribution assumption. On the other hand, the analysis with a general non-stationary distribution is much more complicated because the expected value in (24) for different numerals may not be identical to each other. Nevertheless, (27) is a closed-form expression and predict the performance of the scheme for a given configuration roughly without using sophisticated expressions, as exemplified in Section V.

Based on (27), we infer the followings:
The BMSE decreases with the base β as both E_{channel} and E_{quan} tend to be smaller with a larger β. While increasing the number of numerals D decreases the factor E_{quan}, its impact on the factor E_{channel} is limited as the limit of β^{D}+1/(β^{D}−1) is 1 as D approaches infinity.
BMSE decreases with the number of antennas in the cases where the impact of the quantization error on the error is small for a larger β or D.
The impact of the quantization error (either by increasing β or D) on the BMSE rapidly diminishes for a larger β or D.
The impact of σₙ² on the BMSE decreases with the number of EDs K.
The BMSE asymptotically decreases to vₘₐₓ²/(3Rβ)for large K and β^{D}.

As we show in Section IV and demonstrate in Section V, the amount of BMSE plays a major role for the convergence rate of the FEEL. To reduce BMSE for FEEL, we introduce a simple method in the following subsection.

### E. Adaptive Absolute Maximum (AAM)

Without any adaptation, the BMSE in (27) is a constant and the error due to the presently disclosed scheme can dominate the estimate of v_{q}⁽ [symbol] ⁾ when its value is closer to 0. This can be a non-negligible issue in practice because the gradients tend to become smaller over time. To address this issue, we exploit the fact that the gradients between adjacent communication rounds may have a high correlation [36] and propose to improve the presently disclosed scheme with a feedback loop where all the EDs transmit only a single parameter related to their local gradients to the ES through a control channel (e.g., PUCCH in 3GPP 5G NR) and the ES sets up a new absolute maximum vmax for the next communication round based on the received feedback from the EDs. The information that are transmitted from ED can be a function of the maximum absolute value of the gradients, the empirical variance, standard deviation, or the mean of the gradients. In this disclosure, we assume that the feedback loop realizes the AAM as:

vₘₐₓ⁽ [symbol] ⁾=α×∥m⁽ [symbol] ⁻¹⁾∥_{∞}, (28)

where m⁽ [symbol] ⁾=[m₀⁽ [symbol] ⁾, . . . , m_{K-1}⁽ [symbol] ⁾] is the metric vector, mₖ⁽ [symbol] ⁾ is the metric for the kth ED, ∀k, α is a positive value, and vₘₐₓ⁽⁰⁾ is the initial value for the AAM.

The AAM based on (28) can be implemented in a practical network as follows: 1) The kth ED transmit mₖ⁽ [symbol] ⁾, ∀k, at the tth communication round through an orthogonal channel; 2) The ES calculates (28); 3) The ES transmits vₘₐₓ⁽ [symbol] ⁻¹⁾ to the EDs; and 4) The EDs update their ƒ_{enc,β}based on the new absolute maximum vₘₐₓ⁽ [symbol] ⁻¹⁾.

In this disclosure, we choose mₖ⁽ [symbol] ⁾ and α as mₖ⁽ [symbol] ^{)=∥\tilde{g}}ₖ⁽ [symbol] ⁾∥₂ and α=\sqrt{Q}, heuristically, based on five-sigma deviation rule. The convergence rate of FEEL with and without AAM is analyzed in Section IV.

### IV. Convergence Analysis

For the convergence rate analysis, we consider well-known Lipschitz continuity [42] and make several assumptions on the loss function and gradient estimates, given as follows:

Definition 1. A function ƒ is L-Lipschitz over a set S with respect to a norm ∥·∥ if there exist a real constant L>0 such that ∥ƒ(y)−ƒ(x)∥≤L∥y−x∥, ∀x,y∈S.

Lemma 1 ([42, Lemma 1.2.3]). For a differentiable function ƒ: RQ→R, let ∇ƒ be L-Lipschitz on RQ with respect to norm ·2. Then, for any y, x from RQ,

$$\vert f ( y ) - f ( x ) - ∇ {f ( x )}^{T} ( y - x ) \vert \leq \frac{L}{2} {‖ y - x ‖}_{2}^{2} . \qquad ( 29 )$$

Assumption 1 (Bounded loss function). The loss function is bounded, i.e., F(w)≥F*, ∀w.

Assumption 2 (Smooth gradients). The gradient of the loss function, i.e., ∇F, is L-Lipschitz on [symbol] ^{Q} Q with respect to norm ∥·∥₂, i.e.,

∥∇F(w′)−∇F(w)∥₂≤L∥w′−w∥₂, ∀w,w′∈ [symbol] ^{Q}.

Assumption 1 and Assumption 2 are the standard assumptions that are often made in the literature for convergence analysis.

Assumption 3 (Unbiased average local stochastic gradients). For all w⁽ [symbol] ⁾, the average stochastic gradient vector is an unbiased estimate of the global gradient vector, i.e.,

[symbol]

[v⁽ [symbol] ⁾]=g⁽ [symbol] ⁾.

Assumption 4 (Gradient divergence). For all w⁽ [symbol] ⁾, the second order moments of the local stochastic gradients of the kth ED with respected to the global gradients is bounded as:

[symbol]

[∥\tilde{g}ₖ⁽ [symbol] ⁾−g⁽ [symbol] ⁾∥₂²]≤δₖ, ∀k.

Assumption 3 and Assumption 4 do not require the local gradients to be an unbiased estimates of the global gradients. Hence, they are compatible with a heterogeneous data distribution scenario where the sum of local gradients are unbiased.

Assumption 5 (Average quantization error). The quantization error in average is zero, i.e.,

[symbol]

[v_{q}⁽ [symbol] ⁾ v̅_{q}⁽ [symbol] ⁾]=0, ∀k.

Assumption 6 (MSE bound). The average MSE due to the communication channel and the quantization is bounded by σ_{channel}² +σ_{quan}², i.e.,

[symbol]

[(\hat{v}_{q}⁽ [symbol] ⁾−v_{q}⁽ [symbol] ⁾)²]≤σ_{channel}²+σ_{quan}²,

and σ_{channel}²+σ_{quan}² is given in (27).

Theorem 1. For a fixed learning rate η, the convergence rate of the distributed training based on the presently disclosed scheme in Rayleigh channel is:

$$[ \frac{1}{T} {\sum }_{ℓ = 0}^{T - 1} {‖ {g}^{( 𝓉 )} ‖}_{2}^{2} ] \leq \frac{1}{T η ( 1 - \frac{η L}{2} )} ( F ( {w}^{( 0 )} ) - {F}^{*} ) + \frac{\frac{η L}{2}}{1 - \frac{η L}{2}} ( ( {σ}_{channel}^{2} + {σ}_{quan}^{2} ) Q + \frac{1}{K} {\sum }_{k = 0}^{K - 1} {δ}_{i} ) , \qquad ( 30 )$$

where σ_{channel}² and σ_{quan}² are given in (25) and (26), respectively.

The proof is given in Appendix A.

Theorem 1 is an extension of the convergence analysis of SGD under the consideration of the presently disclosed scheme. While the first term of the bound given in (30) becomes smaller for a larger total number of communication rounds T, the noise ball is determined with the values of the learning rate η, the noise variance due to the local stochastic gradient estimates, and the noise due to the presently disclosed scheme. The noise ball decreases when a smaller learning rate η is used at the expense of a larger T due to the first term in (30). The presently disclosed scheme contributes to the noise variance due to stochastic gradient calculation in (11) in an additive manner. Hence, the standard tuning methods for SGD such as momentum can also be utilized with the presently disclosed scheme to improve the convergence rate.

The convergence rate of the FEEL under the presence of the presently disclosed scheme with AAM based on (28) can be expressed as follows:

Theorem 2. For a fixed learning rate η, the convergence rate of the distributed training based on the presently disclosed scheme in Rayleigh fading channel is:

$$[ \frac{1}{T} {\sum }_{ℓ = 1}^{T} {‖ {g}^{( 𝓉 )} ‖}_{2}^{2} ] \leq \frac{1}{T η ( 1 - \frac{η {L}^{′}}{2} )} ( F ( {w}^{( 1 )} ) - {F}^{*} + \frac{η L}{2} {α}^{2} {E}_{total} K [ {‖ {g}^{( 0 )} ‖}_{2}^{2} - {‖ {g}^{( T )} ‖}_{2}^{2} ] ) + \frac{\frac{η {L}^{′}}{2}}{1 - \frac{η {L}^{′}}{2}} \frac{1}{K} {\sum }_{k = 0}^{K - 1} {δ}_{i} , \qquad ( 31 )$$

where L′=L(1 +α²EₜₒₜₐₗK) for U_{q ,i,} [symbol] ˜ [symbol] (K, 1/β) for all [symbol] , i, q.

The proof is given in Appendix B.

Theorem (2) shows that the AAM eliminates the additive impact of the presently disclosed scheme to the noise on the gradients (as in Theorem 1) at the expense of scaling up the constant L. As compared to the case without AAM, the noisy ball is smaller with AAM. Hence, the convergence rate improves considerably, as demonstrated in Section V.

### V. Numerical Results

In this section, we assess the presently disclosed scheme numerically. We demonstrate its BMSE performance and provide the test accuracy results based on FEEL under homogeneous and heterogeneous data distributions.

### A. MSE

In this subsection, we demonstrate the divergence from the theoretical BMSE of the estimator of (19), given in (27). To this end, we calculate the BMSE through a simulation for both uniform distribution discussed in Section III-D and a zero-mean Gaussian distribution with the variance 0.2. We assume σₙ²=0.01, vₘₐₓ=1, and K=25 and consider D∈{1, 2} and β∈{3, 5, 7}. Also, the channel coefficients are assumed to be independent.

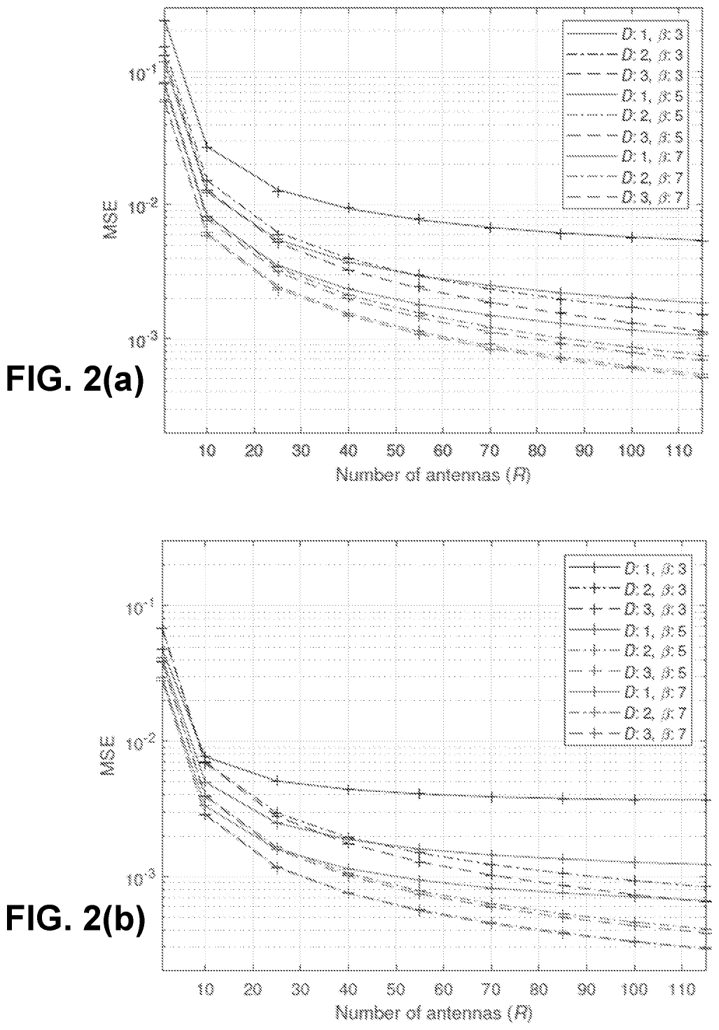

In FIG. 2(a) and FIG. 2(b), we plot the BMSE versus number of antennas for the uniform and Gaussian distributions, respectively. As can be seen from FIG. 2(a), the simulation results exactly match with the theoretical results. The results are also aligned with the discussions provided in Section III-D. Increasing β reduces the BMSE. While a larger D decreases the BMSE (by reducing the quantization error), its impact on the BMSE quickly saturates. Similar observations can also be made from FIG. 2(b) although the distribution is different from the uniform distribution. We also observe that the theoretical BMSE results are more pessimistic than the ones in this scenario. For example, the BMSE results for the uniform and Gaussian distribution for a single antenna is around 0.2 and 0.07, respectively.

Stated another way, FIGS. 2(a) and 2(b) illustrate BMSE versus number of antennas for uniform distribution and zero-mean Gaussian distribution with the variance 0.2 for different numbers of β and D (σₙ²=0.01, vₘₐₓ=1, K=25). In particular, FIG. 2(a) illustrates Uniform distribution (Marker ‘+’: Simulation, Line ‘−’: Theory), while FIG. 2(b) illustrates Gaussian distribution (Simulation).

### B. FEEL

To numerically analyze OAC with the presently disclosed scheme for FEEL, we consider the learning task of handwritten-digit recognition in a single cell with K=25 EDs. We set the SNR, i.e., 1/σₙ², to be 20 dB, and choose the number of antennas at the ES as R∈{1, 25}. For the fading channel, we consider ITU Extended Pedestrian A (EPA) with no mobility and regenerate the channels between the ES and the EDs independently for each communication round to capture the long-term channel variations. The subcarrier spacing is set to 15 kHz. We use M=1200 subcarriers (i.e., the signal bandwidth is 18 MHz). Hence, the difference between time of arriving ED signals is maximum T_{sync}=55.6 ns. We assume that the synchronization uncertainty at the ES is Nₑᵣᵣ=3 samples. For the comparisons, we consider FSK-MV proposed in [20 ] as it is based on a non-coherent detection and provides robustness against time-synchronization errors. We do not consider methods rely on TCI as their performance can deteriorate quickly in the cases of time-synchronization errors [20], [21 ] or imperfect CSI [19]. For the presently disclosed scheme, we consider β∈{3, 5, 7} and D={1, 2}.

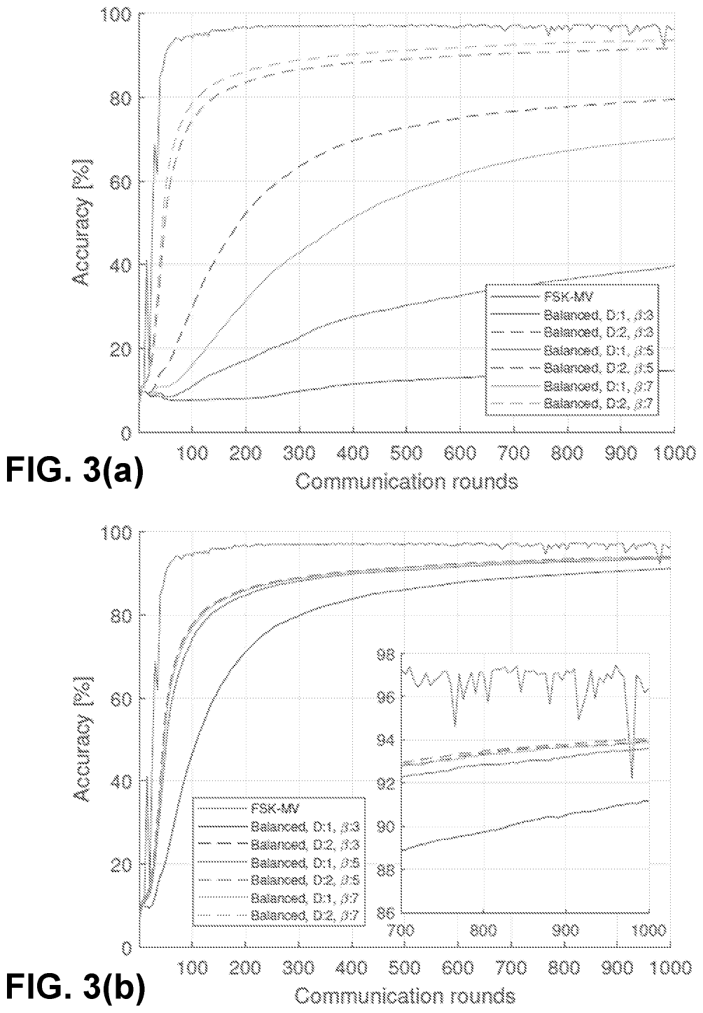

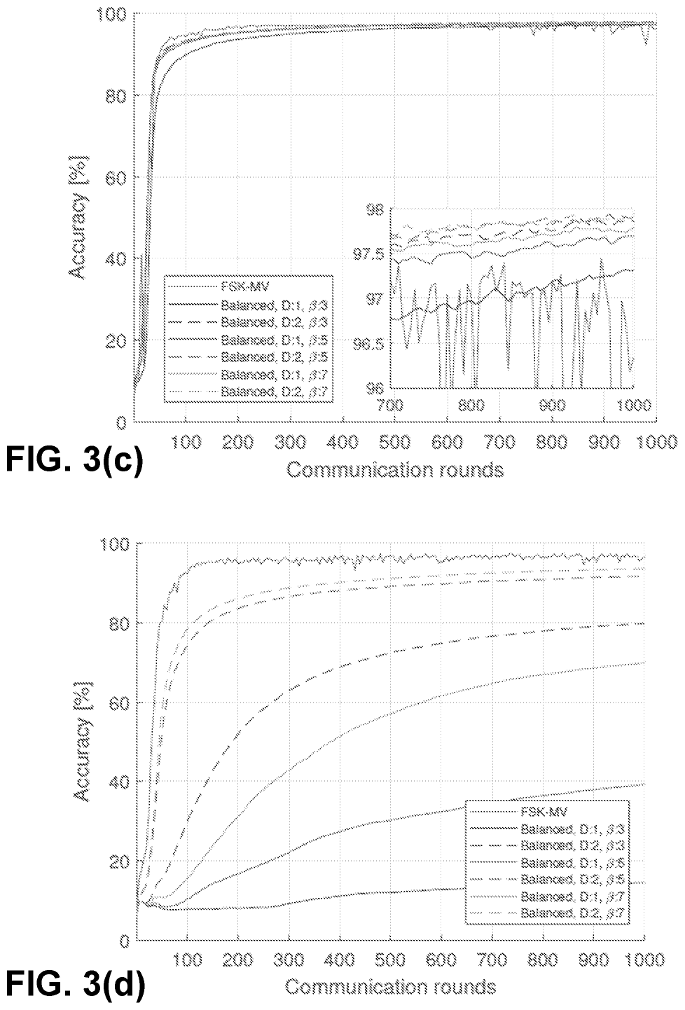

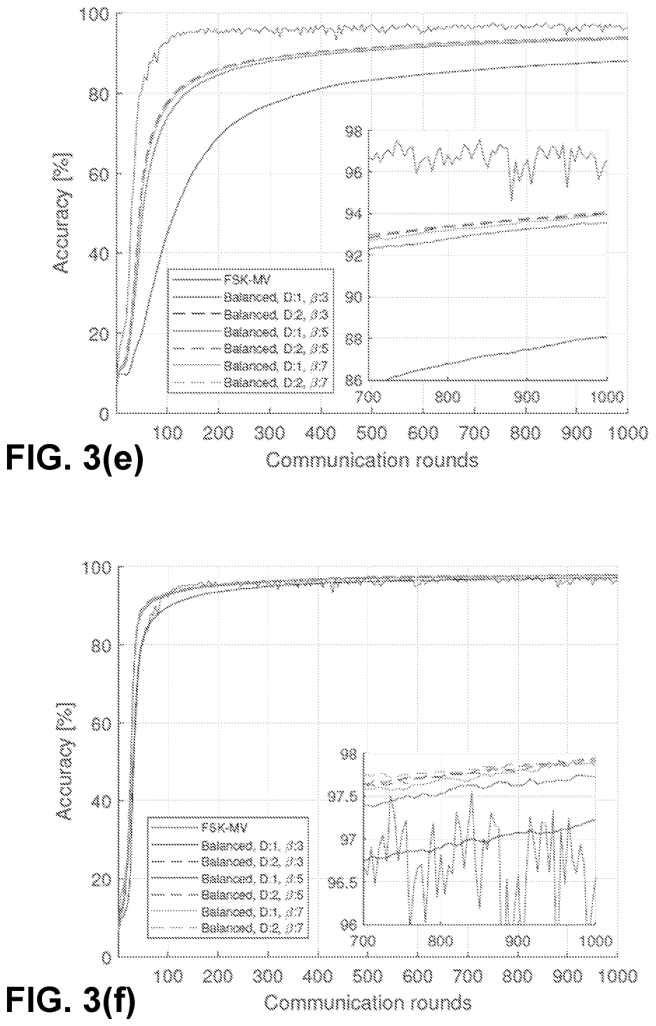

For the local data at the EDs, we use the MNIST database that contains labeled handwritten-digit images size of 28×28 from digit 0 to digit 9. We distribute the data samples in the MNIST database to the EDs to generate representative results for FEEL. We consider both homogeneous and heterogeneous data distributions in the cell. To prepare the data, we first choose | [symbol] |=25000 training images from the database, where each digit has distinct 2500 images. For the scenario with the homogeneous data distribution, we assume that each ED has 250 distinct images for each digit. As done in [20], for the scenario with the heterogeneous data distribution, we divide the cell into 5 areas with concentric circles and the EDs located in uth area have the data samples with the labels {u−1, u, 1+u, 2+u, 3+u, 4+u} for u∈{1, . . . , 5} (See [20, FIG. 3] for an illustration). The number of EDs in each area is 5. As discussed in Section II, we assume that the path loss is compensated through a power control mechanism. For the model, we consider a convolution neural network (CNN) given in Table I (as an example of a neural network at the EDs, showing layers, learnables, and activations). At the input layer, standard normalization is applied to the data. Our model has Q=123090 learnable parameters. For the update rule, the learning rate is set to 0.001. The batch size n_{b} is set to 64. To demonstrate the compatibility of the presently disclosed scheme to SGD with momentum, we also provide the test accuracy results when momentum is 0.9. For the test accuracy calculations, we use 10000 test samples available in the MNIST database.

In FIG. 3, we provide the test accuracy versus communication rounds for the scenario with homogeneous data distribution. In FIG. 3(a), we set the momentum to be zero and do not consider the AAM. For this scenario, although the accuracy results with the presently disclosed scheme improve for larger β or D (i.e., less σ_{channel}²), the FSK-MV is superior to the presently disclosed scheme. This is because FSK-MV is based on signSGD, while the presently disclosed scheme implements SGD and the presently disclosed scheme increases the noise on the gradient estimates as predicted by Theorem 1. In [22], it was also mentioned that signSGD can outperform SGD by providing stronger weight to the gradient direction as compared to SGD when the gradients are noisy.

In FIG. 3(b), we rerun the simulation when the AAM is enabled. In this case, the convergence rate improves considerably for all β and D since AAM eliminates the additive noise term due to the presently disclosed scheme in Theorem 1. For this case, the performance with the choice of {β=3, D=1} worse than the other configurations since the quantization error is dominant in the case. The best performance is obtained with the FSK-MV due to its inherent benefits of signSGD.

In FIG. 3(c), we re-evaluate the same configurations when SGD is used with the momentum of 0.9 and the AAM is used for the presently disclosed scheme. In this case, both test accuracy and the convergence rate are improved for the presently disclosed scheme. Also, the final test accuracy reaches almost 98%, and better than the one with FSK-MV.

For the curves in FIG. 3(d)-(f), we consider the number of antennas to be 25. Although this improves the BMSE considerably, its impact on the test accuracy is almost negligible. The curves in FIG. 3 indicates that the presently disclosed OAC scheme can achieve notable test accuracy results even when there is only a single antenna at the ES.

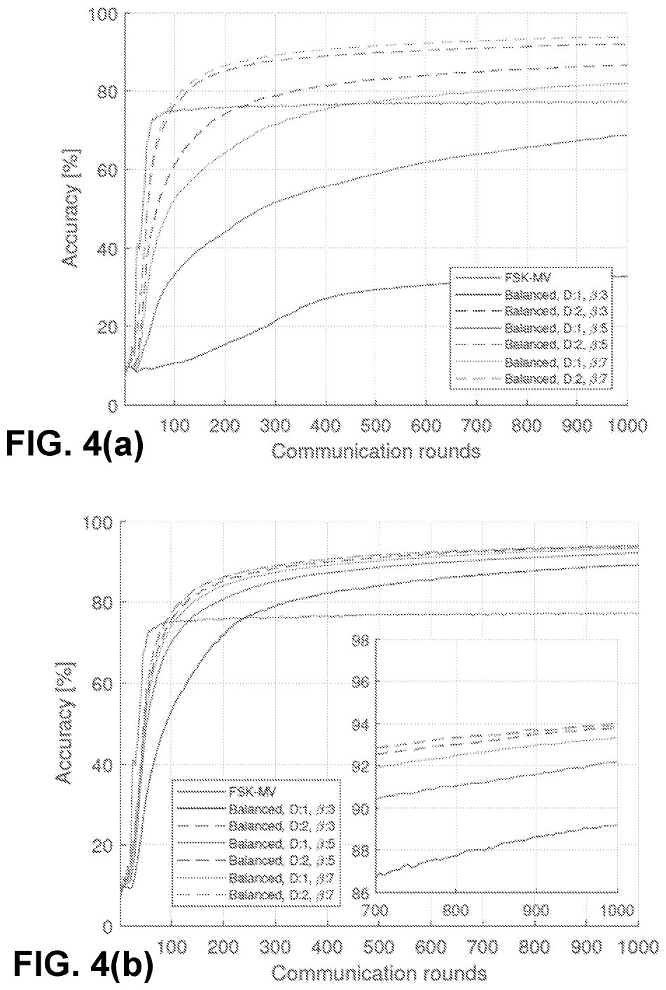

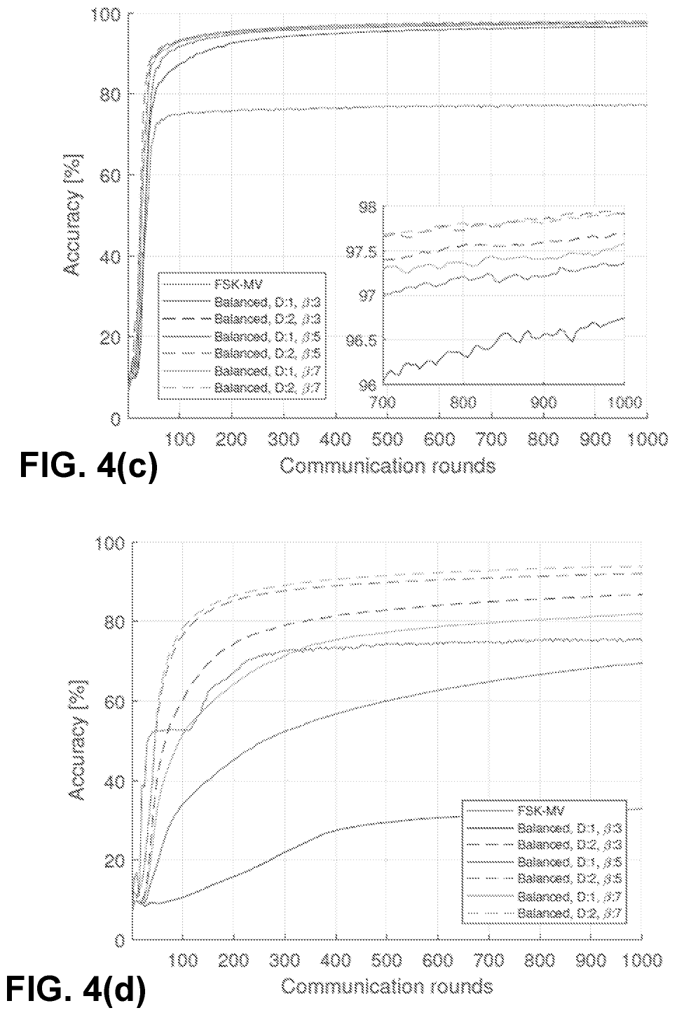

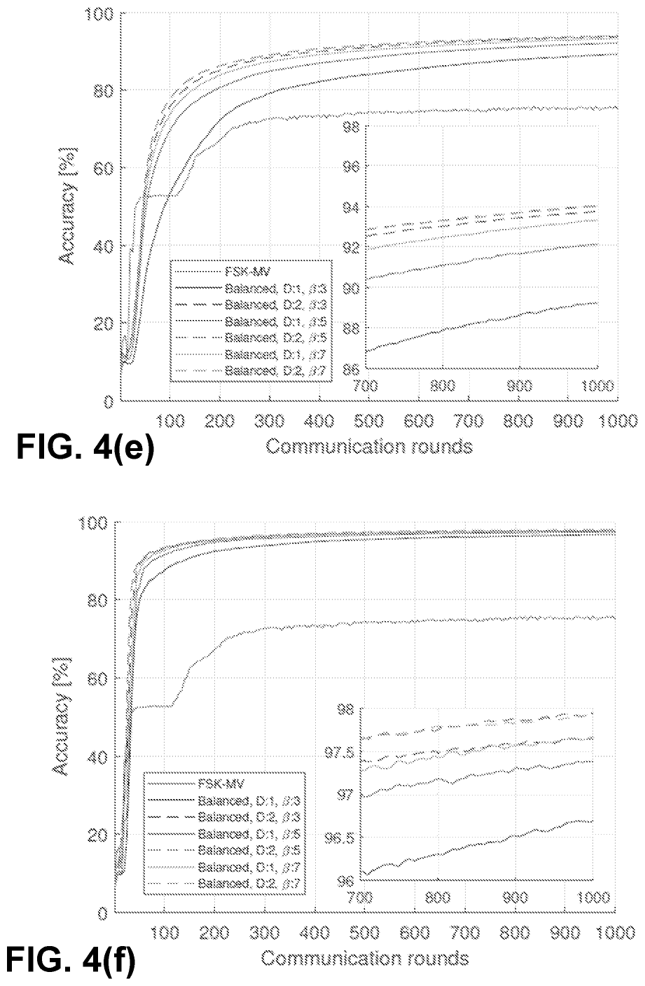

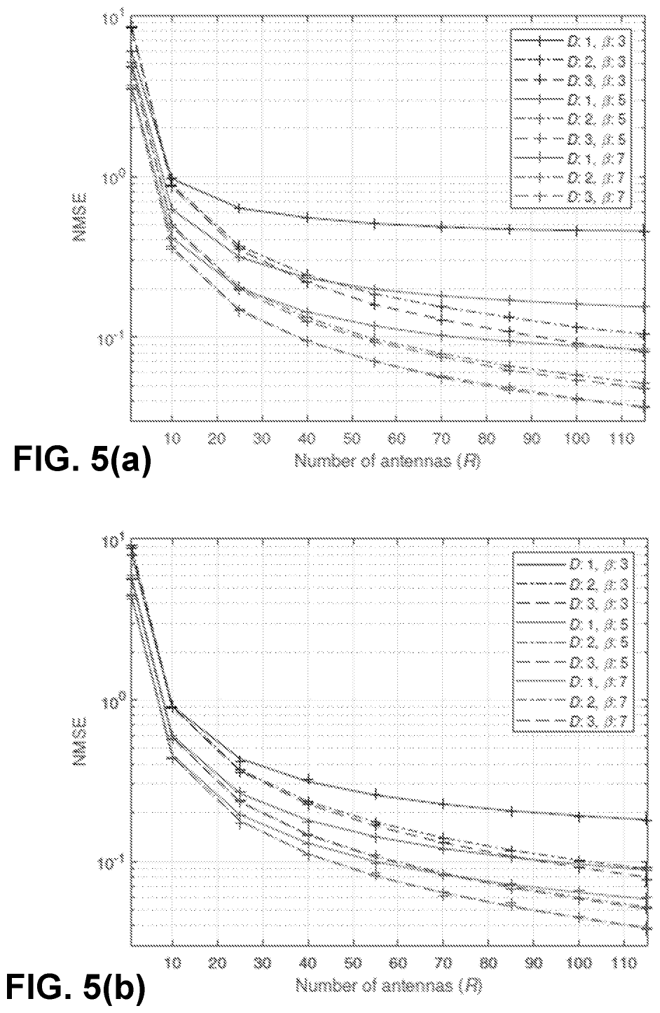

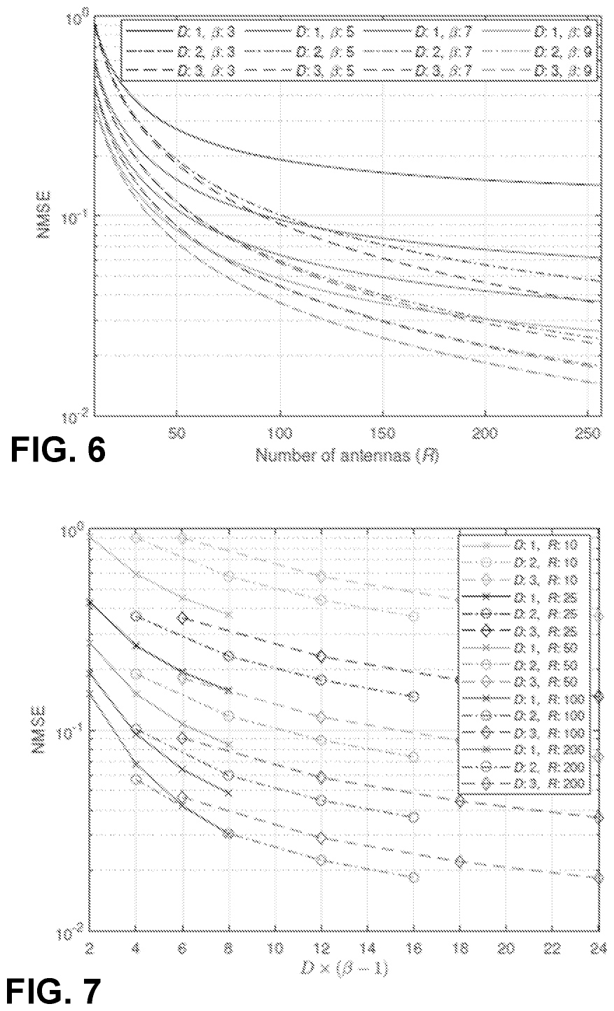

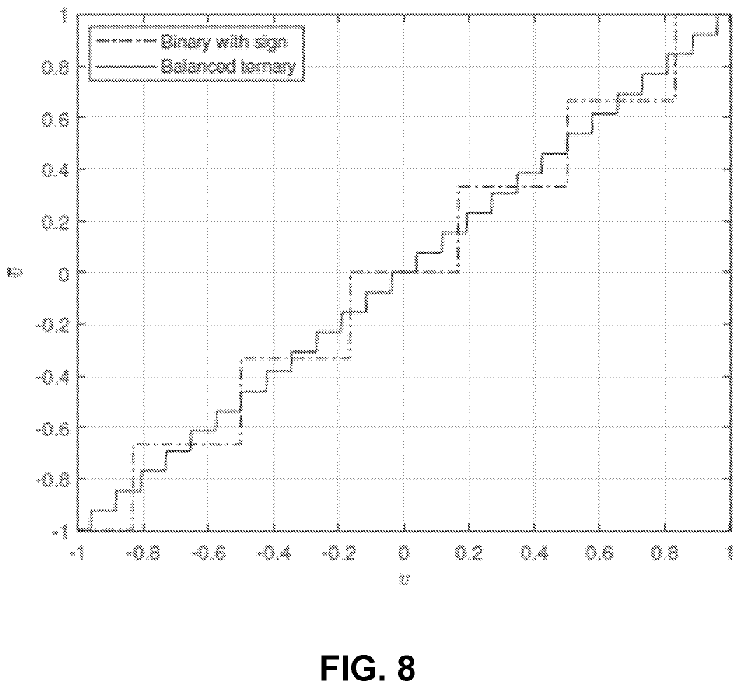

In FIG. 4, the test accuracy is evaluated when the data distribution is highly heterogeneous, i.e., each ED has only 6 unique digits. We use the same parameters used for FIG. 3. In this case, the performance of the FSK-MV degrades drastically, whereas the performance of the presently disclosed scheme is similar to one in FIG. 3. The test accuracy under heterogeneous data distribution is less than 80% for the FSK-MV (this is also reported in [20]). On the other hand, the presently disclosed scheme with large β and D can achieve more than 90% test accuracy as shown in FIG. 4(a)-(c) for R=1. A similar observation can also be made for R=25 as in FIG. 4(d)-(f), i.e., the presently disclosed scheme can provide high test accuracy, up to 98%, even the data distribution is not homogeneous.

### VI. Concluding Remarks

In this disclosure, we investigate an OAC method that exploits balanced number systems for gradient aggregation. The presently disclosed scheme achieves a continuous-valued computation through a digital scheme by exploiting the fact that the average of the numerals in the real domain can be used to compute the average of the corresponding real-valued parameters approximately. With the presently disclosed OAC method, the local stochastic gradients are encoded into a sequence where the elements of the sequence determine the activated OFDM subcarriers. We also use a non-coherent receiver to eliminate the precise sample-level time synchronization, channel estimation overhead, and power instabilities due to the channel inversion techniques. To improve its MSE performance, we also introduce AAM. We theoretically analyze its MSE performance and its convergence rate for FEEL that consider both homogeneous and heterogeneous distributions. Our numerical results demonstrate that the test accuracy of the FEEL with the presently disclosed scheme using AAM can reach up to 98% even when the EDs do not have the labels in their data sets.

The presently disclosed scheme provides a potentially rich area to be investigated. For example, in this disclosure, we consider gradient aggregation. On the other hand, one open question is if the presently disclosed scheme can also be utilized for parameter aggregation. Based on our numerical tests, the performance (e.g., test accuracy) can be poor as the neural network may not be tolerant to the errors on the model parameters due to the presently disclosed scheme. Hence, evaluating (and enhancing) the presently disclosed scheme with a noise-tolerant neural network (e.g., quantized neural networks) is an interesting future research direction that can be pursued.

Another interesting direction is the utilization of the presently disclosed OAC scheme along with distributed source coding to reduce the per-round communication latency further.

This written description uses examples to disclose the presently disclosed subject matter, including the best mode, and also to enable any person skilled in the art to practice the presently disclosed subject matter, including making and using any devices or systems and performing any incorporated methods. The patentable scope of the presently disclosed subject matter is defined by the claims, and may include other examples that occur to those skilled in the art. Such other examples are intended to be within the scope of the claims if they include structural and/or step elements that do not differ from the literal language of the claims, or if they include equivalent structural and/or elements with insubstantial differences from the literal languages of the claims.

### APPENDIX A

### Proof of Theorem 1

Proof. By Assumption 2, we utilize Lemma 1 to obtain the following inequality:

$$F ( {w}^{( 𝓉 + 1 )} ) - F ( {w}^{( 𝓉 )} ) \leq - η {g}^{{( 𝓉 )}^{T}} {\hat{v}}^{( 𝓉 )} + \frac{{η}^{2}}{2} L {‖ {\hat{v}}^{( 𝓉 )} ‖}_{2}^{2} , \\ {for}^{{w}^{( 𝓉 + 1 )} = {w}^{( 𝓉 )} - η {\hat{v}}^{( 𝓉 )}} .$$

By using Assumption 3-6, we obtain the identities given by:

$$[ {g}^{{( 𝓉 )}^{T}} {\hat{v}}^{( 𝓉 )} ] = [ {g}^{{( 𝓉 )}^{T}} {v}^{( 𝓉 )} ] = {‖ {g}^{( 𝓉 )} ‖}_{2}^{2} ,$$

$${𝔼}_{{\hat{v}}^{( 𝓉 )}} [ {‖ {\hat{v}}^{( 𝓉 )} ‖}_{2}^{2} ] = {\underbrace{{[ {‖ {\hat{v}}^{( 𝓉 )} ‖}_{2} ]}^{2}}}_{= {‖ {g}^{( 𝓉 )} ‖}_{2}^{2}} + {\underbrace{[ {‖ {\hat{v}}^{( 𝓉 )} - {v}^{( 𝓉 )} ‖}_{2}^{2} ]}}_{= ( {σ}_{channel}^{2} + {σ}_{quan}^{2} ) Q} + {\underbrace{[ {‖ {v}^{( 𝓉 )} - {g}^{( 𝓉 )} ‖}_{2}^{2} ]}}_{\leq \frac{1}{K} {\sum }_{k = 0}^{K - 1} {δ}_{i}} .$$

Therefore, the expected improvement can be expressed as:

$$[ F ( {w}^{( 𝓉 + 1 )} ) - F ( {w}^{( 𝓉 )} ) \vert {w}^{( 𝓉 )} ] \leq - η {‖ {g}^{( 𝓉 )} ‖}_{2}^{2} + \frac{{η}^{2}}{2} L ( {‖ {g}^{( 𝓉 )} ‖}_{2}^{2} + ( {σ}_{channel}^{2} + {σ}_{quan}^{2} ) Q + \frac{1}{K} {\sum }_{k = 0}^{K - 1} {δ}_{i} ) .$$

We then use Assumption 1, perform a telescoping sum over the iterations and calculate the expectation over the randomness in the trajectory as:

$$F ( {w}^{( 0 )} ) - {F}^{*} \geq F ( {w}^{( 0 )} ) - [ F ( {w}^{( T )} ) ] = [ {\sum }_{𝓉 = 0}^{T - 1} F ( {w}^{( 𝓉 )} - F ( {w}^{( 𝓉 + 1 )} ) ] \geq ( - η + \frac{{η}^{2} L}{2} ) [ {\sum }_{𝓉 = 0}^{T - 1} {‖ {g}^{( 𝓉 )} ‖}_{2}^{2} ] + \frac{{η}^{2} LT}{2} ( ( {σ}_{channel}^{2} + {σ}_{quan}^{2} ) Q + \frac{1}{K} {\sum }_{k = 0}^{K - 1} {δ}_{i} ) .$$

By rearranging the terms, (30) is reached.

### APPENDIX B

### Proof of Theorem 2

Proof. The proof of Theorem 2 is similar to that of Theorem 1. By Assumption 2, we use Lemma 1 to express the following inequality:

$$F ( {w}^{( 𝓉 + 1 )} ) - F ( {w}^{( 𝓉 )} ) \leq - η {g}^{{( 𝓉 )}^{T}} {\hat{v}}^{( 𝓉 )} + \frac{{η}^{2}}{2} L {‖ {\hat{v}}^{( 𝓉 )} ‖}_{2}^{2} ,$$

for w⁽ [symbol] ⁺¹⁾=w [symbol] ⁾−η\hat{v}⁽ [symbol] ⁾. By using Assumption 3, Assumption 4, (27), and (26), we calculate:

$$[ {g}^{{( 𝓉 )}^{T}} {\hat{v}}^{( 𝓉 )} ] = [ {g}^{{( 𝓉 )}^{T}} {v}^{( 𝓉 )} ] = {‖ {g}^{( 𝓉 )} ‖}_{2}^{2} ,$$

$$[ {‖ {\hat{v}}^{( 𝓉 )} ‖}_{2}^{2} ] = {{𝔼}_{{\hat{v}}^{( 𝓉 )}} [ {‖ {\hat{v}}^{( 𝓉 )} ‖}_{2} ]}^{2} + {𝔼}_{{\hat{v}}^{( 𝓉 )}} [ {‖ {v}^{( 𝓉 )} - {g}^{( 𝓉 )} ‖}_{2}^{2} ] + {𝔼}_{{\hat{v}}^{( 𝓉 )}} [ {‖ {\hat{v}}^{( 𝓉 )} - {v}^{( 𝓉 )} ‖}_{2}^{2} ] .$$

Let bₖ⁽ [symbol] ⁾ [symbol] [symbol] [\tilde{g}ₖ⁽ [symbol] ⁾−g⁽ [symbol] ⁾] be the bias vector. Based on Assumption 4,

[symbol]

[∥\tilde{g}ₖ⁽ [symbol] ⁾∥₂²]= [symbol] [∥\tilde{g}ₖ⁽ [symbol] ^{)-g}ₖ⁽ [symbol] ⁾∥₂²]−∥g⁽ [symbol] ⁾∥₂²−2g⁽ [symbol] ⁾^{^{T}}bₖ⁽ [symbol] ⁾≤δₖ+∥g⁽ [symbol] ⁾∥₂²+2g⁽ [symbol] ⁾^{^{T}}bₖ⁽ [symbol] ⁾. (32)

Therefore, based on (28), (32), and by Assumption 3,

$$\begin{matrix}{{\hat{v}}^{( 𝓉 )}}_{} [ {‖ {\hat{v}}^{( 𝓉 )} - {v}^{( 𝓉 )} ‖}_{2}^{2} ] = {E}_{total} {\{ {\tilde{g}}_{k}^{( 𝓉 - 1 )} \}}_{} [ {v}_{max}^{{( 𝓉 )}^{2}} ] \\ = {α}^{2} {E}_{total} {\{ {\tilde{g}}_{k}^{( 𝓉 - 1 )} \}}_{} [ {‖ {m}^{( 𝓉 - 1 )} ‖}_{∞}^{2} ] \\ \leq {α}^{2} {E}_{total} {\{ {\tilde{g}}_{k}^{( 𝓉 - 1 )} \}}_{} [ {‖ {m}^{( 𝓉 - 1 )} ‖}_{2}^{2} ] \\ = {α}^{2} {E}_{total} {\{ {\tilde{g}}_{k}^{( 𝓉 - 1 )} \}}_{} [ {\sum }_{k = 0}^{K - 1} {‖ {\tilde{g}}_{k}^{( 𝓉 - 1 )} ‖}_{2}^{2} ] \\ = {α}^{2} {E}_{total} {\sum }_{k = 0}^{K - 1} {{\tilde{g}}_{k}^{( 𝓉 - 1 )}}_{} [ {‖ {\tilde{g}}_{k}^{( 𝓉 - 1 )} ‖}_{2}^{2} ] \\ \leq {α}^{2} {E}_{total} ( K {‖ {g}^{( 𝓉 - 1 )} ‖}_{2}^{2} + {\sum }_{k = 0}^{K - 1} {δ}_{k} + 2 {g}^{{( 𝓉 - 1 )}^{T}} {\underbrace{{\sum }_{k = 0}^{K - 1} {b}_{k}^{( 𝓉 - 1 )}}}_{= 0} )\end{matrix} .$$

Therefore, the expected improvement with AAM can be expressed as:

$${{\hat{v}}^{( 𝓉 )}}_{} [ F ( {w}^{( 𝓉 + 1 )} ) - F ( {w}^{( 𝓉 )} ) \vert {w}^{( 𝓉 )} ] \leq ( - η + \frac{{η}^{2}}{2} L ) {‖ {g}^{( 𝓉 )} ‖}_{2}^{2} + \frac{{η}^{2}}{2} L {α}^{2} {E}_{total} K {‖ {g}^{( 𝓉 - 1 )} ‖}_{2}^{2} + \frac{{η}^{2}}{2} L ( {α}^{2} {E}_{total} K + 1 ) \frac{1}{K} {\sum }_{k = 0}^{K - 1} {δ}_{i} . \qquad ( 33 )$$

Considering Assumption 1, we perform a telescoping sum over the iterations and calculate the expectation over the randomness in the trajectory as:

$$F ( {w}^{( 1 )} ) - {F}^{*} \geq F ( {w}^{( 1 )} ) - [ F ( {w}^{( T )} ) ] = [ {\sum }_{𝓉 = 1}^{T} F ( {w}^{( 𝓉 )} ) - F ( {w}^{( 𝓉 + 1 )} ) ] \geq ( - η + \frac{{η}^{2} L}{2} ) [ {\sum }_{𝓉 = 1}^{T} {‖ {g}^{( 𝓉 )} ‖}_{2}^{2} ] + \frac{{η}^{2}}{2} L {α}^{2} {E}_{total} K [ {\sum }_{𝓉 = 1}^{T} {‖ {g}^{( 𝓉 - 1 )} ‖}_{2}^{2} ] + \frac{{η}^{2} LT}{2} ( {α}^{2} {E}_{total} K + 1 ) \frac{1}{K} {\sum }_{k = 0}^{K - 1} {δ}_{i} . \qquad ( 34 )$$

Also, we can express the expected value of the sum over the trajectory as:

$$[ {\sum }_{𝓉 = 1}^{T} {‖ {g}^{( 𝓉 - 1 )} ‖}_{2}^{2} ] = [ {\sum }_{𝓉 = 1}^{T} {‖ {g}^{( 𝓉 )} ‖}_{2}^{2} ] + [ {‖ {g}^{( 0 )} ‖}_{2}^{2} - {‖ {g}^{( T ) \vert} ‖}_{2}^{2} ] . \qquad ( 35 )$$

Finally, by using (35) and rearranging the terms in (34), (30) is obtained.

### REFERENCES

[1] B. Nazer and M. Gastpar, “Computation over multiple-access channels,” IEEE Trans. Inf. Theory, vol. 53, no. 10, pp. 3498-3516, October 2007.
[2] M. Gastpar and M. Vetterli, “Source-channel communication in sensor networks,” in Proceedings of the 2nd International Conference on Information Processing in Sensor Networks, ser. IPSN'03. Berlin, Heidelberg: Springer-Verlag, 2003, p. 162-177.
[3] M. Goldenbaum, H. Boche, and S. Stanczak, “Harnessing interference for analog function computation in wireless sensor networks,” IEEE Trans. Signal Process., vol. 61, no. 20, pp. 4893-4906, October 2013.
[4] W. Liu, X. Zang, Y. Li, and B. Vucetic, “Over-the-air computation systems: Optimization, analysis and scaling laws,” IEEE Trans. Wireless Commun., vol. 19, no. 8, pp. 5488-5502, August 2020.
[5] M. Chen, D. Gunduz, K. Huang, W. Saad, M. Bennis, A. V. Feljan, and H. Vincent Poor, “Distributed learning in wireless networks: Recent progress and future challenges,” IEEE J. Sel. Areas Commun., pp. 1-26, 2021.
[6] P. Park, P. Di Marco, and C. Fischione, “Optimized over-the-air computation for wireless control systems,” IEEE Commun. Lett,vol. 26, no. 2, pp. 1-5, 2022.
[7] B. McMahan, E. Moore, D. Ramage, S. Hampson, and B. A. y. Arcas, “Communication-Efficient Learning of Deep Networks from Decentralized Data,” in Proceedings of the 20th International Conference on Artificial Intelligence and Statistics, ser. Proceedings of Machine Learning Research, A. Singh and J. Zhu, Eds., vol. 54. PMLR, 20-22 April 2017, pp. 1273-1282.
[8] M. Chen, Z. Yang, W. Saad, C. Yin, H. V. Poor, and S. Cui, “A joint learning and communications framework for federated learning over wireless networks,” IEEE Trans. Wireless Commun., vol. 20, no. 1, pp. 269-283, 2021.
[9] G. Zhu, Y. Wang, and K. Huang, “Broadband analog aggregation for low-latency federated edge learning,” IEEE Trans. Wireless Commun., vol. 19, no. 1, pp. 491-506, January 2020.
[10] T. Sery, N. Shlezinger, K. Cohen, and Y. C. Eldar, “Over-the-air federated learning from heterogeneous data,” IEEE Transactions on Signal Processing, vol. 69, pp. 3796-3811, 2021.
[11] M. M. Amiri and D. Gunduz, “Federated learning over wireless fading channels,” IEEE Trans. Wireless Commun., vol. 19, no. 5, pp. 3546-3557, February 2020.
[12] G. Zhu, Y. Du, D. Gunduz, and K. Huang, “One-bit over-the-air aggregation for communication-efficient federated edge learning: Design and convergence analysis,” IEEE Trans. Wireless Commun., vol. 20, no. 3, pp. 2120-2135, November 2021.
[13] N. Zhang and M. Tao, “Gradient statistics aware power control for over-the-air federated learning,” IEEE Trans. Wireless Commun., vol. 20, no. 8, pp. 5115-5128, 2021.
[14] H. Hellstrom, V. Fodor, and C. Fischione, “Over-the-air federated learning with retransmissions (extended version),” 2021. [Online]. Available: https://arxiv.org/abs/2111_10267
[15] S. Tang, P. Popovski, C. Zhang, and S. Obana, “Multi-slot over-the-air computation in fading channels,” 2021. [Online]. Available: https://arxiv.org/abs/2010.13559
[16] L. Su and V. K. N. Lau, “Hierarchical federated learning for hybrid data partitioning across multitype sensors,” IEEE Internet of Things Journal, vol. 8, no. 13, pp. 10 922-10 939, January 2021.
[17] X. Zang, W. Liu, Y. Li, and B. Vucetic, “Over-the-air computation systems: Optimal design with sum-power constraint,” IEEE Wireless Commun. Lett., vol. 9, no. 9, pp. 1524-1528, 2020.
[18] M. A. Abdul Careem and A. Dutta, “Real-time prediction of nonstationary wireless channels,” IEEE Trans. Wireless Commun., vol. 19, no. 12, pp. 7836-7850, 2020.
[19] H. Jung and S.-W. Ko, “Performance analysis of UAV-enabled over-the-air computation under imperfect channel estimation,” IEEE Wireless Commun. Lett., pp. 1-1, November 2021.
[20] A., Sahin, B. Everette, and S. Hogue, “Distributed learning over a wireless network with FSK-based majority vote,” in Proc. IEEE International Conference on Advanced Communication Technologies and Networking (CommNet), December 2021, pp. 1-9.
[21] —, “Over-the-air computation with DFT-spread OFDM for federated edge learning,” in Proc. IEEE Wireless Communications and Networking Conference (WCNC), April 2022, pp. 1-6.
[22] J. Bernstein, Y.-X. Wang, K. Azizzadenesheli, and A. Anandkumar, “signSGD: Compressed optimisation for non-convex problems,” in Proc. in International Conference on Machine Learning, vol. 80. Proceedings of Machine Learning Research, 10-15 July 2018, pp. 560-569.
[23] I. Koren, Computer Arithmetic Algorithms, 2nd ed. A K Peters/CRC Press, 2018.
[24] R. Jiang and S. Zhou, “Cluster-based cooperative digital over-the-air aggregation for wireless federated edge learning,” in IEEE/CIC International Conference on Communications in China (ICCC), 2020, pp. 887-892.
[25] B. Chen, R. Jiang, T. Kasetkasem, and P. Varshney, “Channel aware decision fusion in wireless sensor networks,” IEEE Transactions on Signal Processing, vol. 52, no. 12, pp. 3454-3458,2004.
[26] X. Wei, C. Shen, H. J. Yang, and H. V. Poor, “Random orthogonalization for federated learning in massive MIMO systems,” in Proc. IEEE International Conference on Communications (ICC), April 2022, pp. 1-6.
[27] M. M. Amiria, T. M. Duman, D. Gunduz, S. R. Kulkarni, and H. Vincent Poor, “Collaborative machine learning at the wireless edge with blind transmitters,” IEEE Trans. Wireless Commun., pp. 1-1, March 2021.
[28] K. Yang, T. Jiang, Y. Shi, and Z. Ding, “Federated learning via over-the-air computation,” IEEE Trans. Wireless Commun., vol. 19, no. 3, pp. 2022-2035,2020.
[29] M. Goldenbaum and S. Stanczak, “Robust analog function computation via wireless multiple-access channels,” IEEE Trans. Commun., vol. 61, no. 9, pp. 3863-3877,2013.
[30] M. Goldenbaum and S. Stanczak, “Computing the geometric mean over multiple-access channels: Error analysis and comparisons,” in IEEE Asilomar Conference on Signals, Systems and Computers, 2010, pp. 2172-2178.
[31] M. Goldenbaum and S. Stanczak, “On the channel estimation effort for analog computation over wireless multiple-access channels,” IEEE Wireless Commun. Lett., vol. 3, no. 3, pp. 261-264,2014.
[32] M. Goldenbaum, H. Boche, and S. Sta'nczak, “Nomographic functions: Efficient computation in clustered gaussian sensor networks,” IEEE Trans. Wireless Commun., vol. 14, no. 4, pp. 2093-2105, 2015.
[33] D. Alistarh, D. Grubic, J. Z. Li, R. Tomioka, and M. Vojnovic, “Qsgd: Communication-efficient sgd via gradient quantization and encoding,” in Proceedings of the 31st International Conference on Neural Information Processing Systems, ser. NIPS'17. Red Hook, NY, USA: Curran Associates Inc., 2017, p. 1707-1718.
[34] J. Xu, W. Du, Y. Jin, W. He, and R. Cheng, “Ternary compression for communication-efficient federated learning,” IEEE Transactions on Neural Networks and Learning Systems, pp. 1-15,2020.
[35] M. Kim, W. Saad, M. Mozaffari, and M. Debbah, “On the tradeoff between energy, precision, and accuracy in federated quantized neural networks,” 2021. [Online]. Available: https://arxiv.org/abs/2111.07911
[36] K. Liang, H. Zhong, H. Chen, and Y. Wu, “Wyner-ziv gradient compression for federated learning,” 2021. [Online]. Available: https://arxiv.org/abs/2111.08277
[37] E. Dahlman, S. Parkvall, and J. Skold, 5G NR: The Next Generation Wireless Access Technology, 1st ed. USA: Academic Press, Inc., 2018.
[38] H. Rahul, H. Hassanieh, and D. Katabi, “Sourcesync: A distributed wireless architecture for exploiting sender diversity,” in Proceedings of the ACM SIGCOMM 2010 Conference, ser. SIGCOMM '10. New York, NY, USA: Association for Computing Machinery, 2010, p. 171-182. [Online]. Available: https://doi.org/10.1145/1851182.1851204
[39] O. Abari, H. Rahul, D. Katabi, and M. Pant, “Airshare: Distributed coherent transmission made seamless,” in Proc. IEEE Conference on Computer Communications (INFOCOM), 2015, pp. 1742-1750.
[40] G. H. Hardy and E. M. Wright, An Introduction to the Theory of Numbers, 6th ed. Oxford, 2008.
[41] P. Liu, J. Jiang, G. Zhu, L. Cheng, W. Jiang, W. Luo, Y. Du, and Z. Wang, “Training time minimization for federated edge learning with optimized gradient quantization and bandwidth allocation,” 2021. [Online]. Available: https://arxiv.org/abs/2112.14378
[42] Y. Nesterov, Introductory Lectures on Convex Optimization: A Basic Course, ser. Mathematics and its applications. Kluwer Academic Publishers, 2004.

What is claimed is:

1. An over-the-air computation (OAC) methodology for federated edge learning (FEEL) without using pre-equalization or channel state information (CSI) at a plurality of edge devices (EDs) or at an edge server (ES), comprising:
providing a distributed machine-learning model to be trained with the update vectors received at an edge server (ES) as transmitted from a plurality of edge devices (EDs); and
performing methodology operations comprising:
transmitting local update vectors as real-valued local stochastic gradients from each respective of the plurality of edge devices (EDs) via a wireless multiple access channel,
receiving the superposed local update vectors at the ES, and
inputting the superposed local update vectors into the machine-learning model to be updated,
wherein the real-valued local stochastic gradients are encoded into a set of numerals based on a balanced number system to achieve a continuous-valued computation over a digital scheme.

2. The over-the-air computation (OAC) methodology according to claim 1, wherein the EDs activate associated dedicated time-frequency resources based on the values of the numerals.

3. The over-the-air computation (OAC) methodology according to claim 2, wherein the dedicated time-frequency resources comprise orthogonal frequency division multiplexing (OFDM) subcarriers.

4. The over-the-air computation (OAC) methodology according to claim 3, wherein the EDs simultaneously transmit their OFDM symbols.

5. The over-the-air computation (OAC) methodology according to claim 4, wherein average numerals are calculated at the ES with a non-coherent receiver, based on which the ES computes an estimate of the real-valued average stochastic gradient.

6. The over-the-air computation (OAC) methodology according to claim 1, wherein each ED shares a single parameter with the ES to adjust the maximum quantization level as an adaptive absolute maximum (AAM) to minimize the estimation error over the communication rounds of FEEL.

7. The over-the-air computation (OAC) methodology according to claim 6, wherein the single parameter sharing comprises all the EDs transmit to the ES through a control channel only a single parameter related to the local gradients of the EDs.

8. The over-the-air computation (OAC) methodology according to claim 7, wherein the ES sets up a new absolute maximum vₘₐₓ for the next communication round based on the received feedback from the EDs.

9. The over-the-air computation (OAC) methodology according to claim 7, wherein the control channel comprises a physical uplink control channel (PUCCH) in 3rd Generation Partnership Project (3GPP) Fifth Generation (5G) New Radio.

10. The over-the-air computation (OAC) methodology according to claim 7, wherein the information that are transmitted from each ED comprises one or more of a function of the maximum absolute value of the gradients, the empirical variance, standard deviation, or the mean of the gradients.

11. The over-the-air computation (OAC) methodology according to claim 1, further comprising a feedback loop where all the EDs transmit only a single parameter related to their local gradients to the ES through a control channel, and the ES sets up a new absolute maximum vₘₐₓ for the next communication round based on the received feedback from the EDs.

12. The over-the-air computation (OAC) methodology according to claim 1, wherein at the kth ED, β−1 subcarriers are dedicated for each numeral and one of them is activated based on its value.

13. The over-the-air computation (OAC) methodology according to claim 12, wherein no subcarrier is allocated for a_{β-1}=0.

14. The over-the-air computation (OAC) methodology according to claim 12, further comprising calculating a modulation symbol for a gradient, and after the calculation of a modulation symbol for all gradients, the kth ED calculates the orthogonal frequency division multiplexing (OFDM) symbols and all EDs transmit them simultaneously.

15. An over-the-air computation (OAC) system for federated edge learning (FEEL) without using pre-equalization or channel state information (CSI) at a plurality of edge devices (EDs) or at an edge server (ES), comprising:
a distributed machine-learning model training to process data comprising update vectors received at an edge server (ES) as transmitted from a plurality of edge devices (EDs);
one or more processors; and
one or more non-transitory computer-readable media that store instructions that, when executed by the one or more processors, cause the one or more processors to perform operations, the operations comprising:
transmitting local update vectors as real-valued local stochastic gradients from each respective of the plurality of edge devices (EDs) via a wireless multiple access channel,
receiving the superposed local update vectors at the ES, and
inputting the superposed local update vectors into the machine-learning model to be updated,
wherein the real-valued local stochastic gradients are encoded into a set of numerals based on a balanced number system to achieve a continuous-valued computation over a digital scheme.

16. The over-the-air computation (OAC) system according to claim 1, wherein the operations further comprise that the EDs activate associated dedicated time-frequency resources based on the values of the numerals.

17. The over-the-air computation (OAC) system according to claim 16, wherein the dedicated time-frequency resources comprise orthogonal frequency division multiplexing (OFDM) subcarriers.

18. The over-the-air computation (OAC) system according to claim 17, wherein the operations further comprise that the EDs simultaneously transmit their OFDM symbols.

19. The over-the-air computation (OAC) system according to claim 18, wherein the operations further comprise that average numerals are calculated at the ES with a non-coherent receiver, based on which the ES computes an estimate of the real-valued average stochastic gradient.

20. The over-the-air computation (OAC) system according to claim 15, wherein the operations further comprise that each ED shares a single parameter with the ES to adjust the maximum quantization level as an adaptive absolute maximum (AAM) to minimize the estimation error over the communication rounds of FEEL.

21. The over-the-air computation (OAC) system according to claim 20, wherein the operations further comprise that the single parameter sharing comprises all the EDs transmit to the ES through a control channel only a single parameter related to the local gradients of the EDs.

22. The over-the-air computation (OAC) system according to claim 21, wherein the operations further comprise that the ES sets up a new absolute maximum vₘₐₓ for the next communication round based on the received feedback from the EDs.

23. The over-the-air computation (OAC) system according to claim 21, wherein the control channel comprises a physical uplink control channel (PUCCH) in 3rd Generation Partnership Project (3GPP) Fifth Generation (5G) New Radio.

24. The over-the-air computation (OAC) system according to claim 21, wherein the information that are transmitted from each ED comprises one or more of a function of the maximum absolute value of the gradients, the empirical variance, standard deviation, or the mean of the gradients.

25. The over-the-air computation (OAC) system according to claim 15, further comprising a feedback loop where the operations further comprise that all the EDs transmit only a single parameter related to their local gradients to the ES through a control channel, and the ES sets up a new absolute maximum vₘₐₓ for the next communication round based on the received feedback from the EDs.

26. The over-the-air computation (OAC) system according to claim 15, wherein the operations further comprise that at the kth ED, β−1 subcarriers are dedicated for each numeral and one of them is activated based on its value.

27. The over-the-air computation (OAC) system according to claim 26, wherein no subcarrier is allocated for a_{β-1}=0.

28. The over-the-air computation (OAC) system according to claim 26, wherein the operations further comprise calculating a modulation symbol for a gradient, and after the calculation of a modulation symbol for all gradients, the kth ED calculates the orthogonal frequency division multiplexing (OFDM) symbols and all EDs transmit them simultaneously.
